(19) United States
(12) Patent Application Publication
(10) Pub. No.: US 2010/0257952 A1
(43) Pub. Date: Oct. 14, 2010

(54) DOUBLE CLUTCH TRANSMISSION

(75) Inventors: Wolfgang RIEGER, Friedrichshafen (DE); Matthias REISCH, Ravensburg (DE); Juergen WAFZIG, Eriskirch (DE); Gerhard GUMPOLTSBERGER, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/758,972

(22) Filed: Apr. 13, 2010

(30) Foreign Application Priority Data
Apr. 14, 2009 (DE) 10 2009 002 351.8

(51) Int. Cl. F16H 3/20

(52) U.S. Cl. 74/329

(57) ABSTRACT

A double clutch transmission with two clutches whose input sides are connected to a drive shaft and whose output sides are each connected to one of two transmission input shafts arranged coaxially with respect to one another. At least two countershafts are provided on which toothed idler gearwheels are rotatably supported, and toothed fixed gearwheels are positioned on the two transmission input shafts in a rotationally fixed manner such that it is possible to shift at least a plurality of power shiftable forward gears and at least one reverse gear. A maximum of six gear planes are provided so that at least one winding path gear is shiftable when a coupling device of the second countershaft, associated with the output gear, is disengaged.

This application claims priority from German patent application serial no. 10 2009 00 351.8 filed Apr. 14, 2009.

### FIELD OF THE INVENTION

The present invention relates to a double clutch transmission.

### BACKGROUND OF THE INVENTION

A six-speed or seven-speed double clutch transmission is known from published patent DE 103 05 241 A1. The double clutch transmission comprises two clutches, each of which is connected on its input side to the drive shaft and, on its output side to one of the two transmission input shafts. The two transmission input shafts are placed coaxially relative to each other. Furthermore, two countershafts are situated axially parallel to the two transmission input shafts, with their idler gears engaging the fixed gears of the transmission input shafts. Moreover, coupling devices are held on the countershafts so that they are axially movable and rotationally fixed, in order to be able to shift the respective toothed gearwheels. The chosen transmission ratio is transmitted to a differential through the output gears. In order to realize the desired transmission ratio stages with the known double clutch transmission, a large number of gear planes are necessary, so that the construction space required for installation is not insignificant.

Furthermore, a spur-gear multi-speed transmission is known from published patent DE 38 22 330 A1. The spur-gear multi-speed transmission comprises a double clutch which is shiftable under load, one part of which is connected to a driveshaft, and the other part of which is connected to a hollow driveshaft that is carried on the driveshaft. For certain transmission ratios, the driveshaft can be coupled with the sleeve driveshaft by means of a shift element.

From published patent DE 10 2004 001 961 A1 a power-shift transmission with two clutches is known, each of which is assigned to a subtransmission. The transmission input shafts of the two subtransmissions are placed coaxially to each other, and are engaged with idler gears of the assigned countershafts through fixed gears. The respective idler gears of the countershafts can be connected in a rotationally fixed manner with the respective countershaft by means of assigned shift elements. From this published patent an eight-speed transmission is known, in which an additional shift element is provided for coupling the two transmission input shafts to realize an additional transmission ratio stage. Even the seven-speed transmission in this form requires at least six gear planes in the two subtransmissions, in order to be able to realize the transmission ratio stages. This results in an undesirable lengthening of the construction length in the axial direction, so that the possibility of installation in a vehicle is significantly limited.

Furthermore, from published patent DE 10 2005 028 532 A1 an additional power-shift transmission is known, which includes two input shafts and only one countershaft. For example, an eight-speed transmission in this form requires more than seven gear planes in order to be able to realize the transmission ratio stages including, in particular, the reverse gear transmission ratios. This results in an undesirable lengthening of the construction length in the axial direction.

### SUMMARY OF THE INVENTION

The object of the present invention is to propose a double clutch transmission of the species described at the beginning, wherein a plurality of power-shiftable transmission ratio stages are realized as economically as possible and with the fewest possible parts while requiring little construction space.

Accordingly, a construction-space-optimized double clutch transmission is proposed, whose input sides are connected to a drive shaft, and whose output sides are each connected to one of for example two transmission input shafts which are situated coaxially to each other. The double clutch transmission comprises at least two countershafts or the like, on which toothed gearwheels designed as idler gears are rotatably carried, there being toothed gearwheels designed as fixed gears, at least part of which are engaged with the idler gears, placed in a rotationally fixed manner on the two transmission input shafts. Also provided are a number of coupling devices for connecting an idler gear to a countershaft in a rotationally fixed manner. The double clutch transmission according to the invention has an output gear or constant pinion on each of the countershafts, each of which is coupled with gearing of a drive shaft in order to connect the respective countershaft with the output drive, making a plurality of power-shiftable gears feasible.

According to the invention, the proposed double clutch transmission preferably comprises a maximum of six gear planes, with which at least seven power-shiftable gears are realized with little construction space required. For example, one way in which the maximum of six gear planes can be formed is by at least two dual gear planes, wherein in each dual gear plane one idler gear of the first and second countershafts each is assigned to a fixed gear of one of the transmission input shafts and at least one idler gear is usable for at least two gear speeds, so that at least one winding path gear is shiftable when there is a coupling device that is assigned to one of the output gears and is disengaged.

Besides the dual gear planes, it is also possible to use single gear planes where in each single gear plane an idler gear of the countershafts is assigned to a fixed gear of one of the transmission input shafts. Other constellations are also possible.

Because of the possible multiple use of idler gears, it is possible with the proposed double clutch transmission to realize a maximum number of gear ratios with the fewest possible gear planes, with the first seven forward gears being power-shiftable with sequential design.

To optimize the stepping in the double clutch transmission proposed according to the invention, it is also possible for example to replace a dual gear plane with two single gear planes, by replacing one fixed gear with two fixed gears. That makes it possible to achieve especially harmonic, progressive gear stepping. It is also possible to replace two single gear planes with one dual gear plane.

The proposed double clutch transmission can preferably be designed as an 8-speed transmission with at least seven power-shiftable gear steps. Because of the short construction compared to known transmission arrangements, the double clutch transmission according to the invention is especially suited for a front transverse design in a vehicle. Other types of installation are also possible, however, depending on the type and construction space situation of the vehicle in question.

Preferably, in the proposed double clutch transmission the first and eighth forward gears can be winding path gears. In addition, a reverse gear and/or other gears, for example crawler gears or overdrive gears, can also be designed as winding path gears, and may possibly also be power-shiftable. For example, the first power-shiftable forward gear and the highest gear may be winding path gears. Besides the coupling device provided as a winding path gear shift element on one of the constant pinions, additional shift elements can also be placed on the first and/or second countershafts to realize additional winding path gears. At least one of the two constant pinions is thus shiftably connected to the assigned countershaft. Preferably, four to six gear planes can be realized in the proposed double clutch transmission, with at least two dual gear planes and at least one single gear plane being used.

For example, depending on the design of the first and second countershafts, it is possible for example for three or four shiftable idler gears to be assigned to each, each of them engaging with fixed gears of the assigned transmission input shafts.

If the last or next-to-last gear increment is shifted higher than the one before it, when a downshift is requested by the driver especially high output torque or drive power can be made available.

Advantageously, in the double clutch transmission according to the invention a maximum of five shift points are needed on a countershaft. In total, however, eight shift points on both countershafts together can be sufficient to realize the proposed gear steps. However, additional shift points are also possible.

According to the invention, provision can be made for the idler gear of the second subtransmission to be connectable with the idler gear of the first subtransmission through the at least one additional shift element on the first and/or second countershaft, so that at least one winding path gear can be shifted by means of the shift element.

With the double clutch transmission according to the invention it is thus possible, with a disengaged coupling device on one of the output gears and by means of the at least one shift element, to realize winding path gears, in which toothed gearwheels of both subtransmissions are coupled with each other in order to thereby realize a flow of power through both subtransmissions. The particular shift element serves in this case to couple two idler gears, and thereby brings the transmission input shafts into dependency on each other.

In the double clutch transmission, the arrangement of the shift elements for coupling two particular idler gears can be varied so that the shift elements do not necessarily have to be placed between the idler gears that are to be coupled. Accordingly, other arrangement positions of the particular shift element are also conceivable, in order for example to optimize the linking to an actuator system.

In the double clutch transmission, according to a possible embodiment it can be provided that only four gear planes are provided, for example, where a first gear plane is assigned as a dual gear plane to the two fixed gears of the second transmission input shaft of the second subtransmission, and a second gear plane is assigned as a single gear plane. In addition, a third gear plane and a fourth gear plane are assigned to the two fixed gears of the first transmission input shaft of the first subtransmission, both as dual gear planes.

In another embodiment of the invention, it is also possible for five gear planes to be provided in the proposed double clutch transmission. For example, a first gear plane and a second gear plane can be assigned to the two fixed gears of the second transmission input shaft of the second subtransmission, both as dual gear planes. Furthermore, a third gear plane as a single gear plane or as a dual gear plane, a fourth gear plane as a single gear plane, and a fifth gear plane as a dual gear plane or as a single gear plane can also be assigned to the three fixed gears of the first transmission input shaft of the first subtransmission.

Alternatively, the five gear planes can also be realized by assigning a first gear plane as a dual gear plane or as a single gear plane, a second gear plane as a single gear plane and a third gear plane as a single gear plane to the first three fixed gears of the second transmission input shaft of the second subtransmission, and by assigning a fourth gear plane as a dual gear plane or as a single gear plane and a fifth gear plane as a dual gear plane to the other two fixed gears of the first transmission input shaft of the first subtransmission.

Furthermore, according to a next embodiment six gear planes can be provided. Preferably, a first gear plane as a dual gear plane, a second gear plane as a single gear plane and a third gear plane as a single gear plane can be assigned to the fixed gears of the second transmission input shaft of the second subtransmission. Furthermore, a fourth gear plane as a dual gear plane or as a single gear plane, a fifth gear plane as a single gear plane, and a sixth gear plane as a dual gear plane or as a single gear plane can be assigned to the three fixed gears of the first transmission input shaft of the first subtransmission.

In order to provide the necessary rotation reversal to realize reverse gears in the double clutch transmission according to the invention, it is possible for example to use at least one intermediate gear or the like, which is situated for example on an intermediate shaft. It is also possible for one of the idler gears of a countershaft to serve as the intermediate gear wheel for at least one reverse gear. No additional intermediate shaft is necessary for the reverse gear transmission, since one of the idler gears is engaged both with a fixed gear and with another shiftable idler gear of the other countershaft. Thus the necessary intermediate gear wheel for the reverse gear is positioned on a countershaft as a shiftable idler gear, and also serves to realize at least one additional forward gear. The intermediate gear can also be designed as a stepped gear, independent of whether it is placed on the countershaft or on an additional intermediate shaft. It is also possible for the intermediate gear to not be placed on one of the already existing countershafts, but for example to be provided on another separate shaft, for example a third countershaft.

In order to obtain the desired transmission ratio steps, it can also be provided in the double clutch transmission according to the invention that at least one bidirectionally operative coupling device or the like is situated on each countershaft. The provided coupling devices can each connect an assigned idler gear with the countershaft in a rotationally fixed manner in the activated or engaged state, depending on the direction of operation. In addition, a coupling device or the like operating on one side can also be provided on at least one of the countershafts. The coupling devices used can be for example hydraulically, pneumatically, electrically or mechanically operated clutches, or also form locking claw clutches, as well as any type of synchronization that provides a rotationally fixed connection of an idler gear with a countershaft. It is possible for a bidirectionally operative coupling device to be replaced by two unidirectionally operative coupling devices, or vice versa.

It is conceivable that the indicated positioning options for the toothed gearwheels may be varied, and also that the number of toothed gearwheels and the number of coupling devices may be changed, in order to realize even more power-shiftable or non-power-shiftable gears, as well as to save construction space and parts in the proposed double clutch transmission. In particular, fixed gears from dual gear planes can be divided into two fixed gears for two single gear planes. That makes it possible to improve step changes. In addition, it is possible to exchange the countershafts. The subtransmissions can also be exchanged; i.e., they are mirrored around a vertical axis. In doing so, the hollow shaft and solid shaft are exchanged. This makes it possible for example to place the smallest gearwheel on the solid shaft, in order to further optimize the utilization of the available construction space. In addition, neighboring gear planes can be exchanged, for example, to optimize shaft flexing and/or to link optimally a shift actuating system. Moreover, the particular placement position of the coupling devices at the gear plane can be varied. Furthermore, the direction of action of the coupling devices can also be changed.

The gear numberings used here were defined freely. It is also possible to add a crawler or creeper gear and/or an overdrive or fast gear, in order for example to improve the off-road properties or the acceleration behavior of a vehicle. Furthermore, it is possible to omit a first gear, for example, in order to be able to better optimize the step changes overall. The gear numbering varies logically when these measures are used.

Independent of the particular variant embodiments of the double clutch transmission, the drive shaft and the output shaft may preferably also not be situated coaxially with each other; this realizes an especially space-saving arrangement. For example, the shafts, which are thus positioned spatially one behind the other, may also be offset slightly relatively to each other. With this arrangement, a direct gear with a transmission ratio of one is realizable by means of tooth engagement, and can be advantageously shifted to the sixth through ninth gears relatively freely. Other possible arrangements of the drive shaft and output shaft are also conceivable.

Preferably, the proposed double clutch transmission is equipped with an integrated output stage. The output stage can include, as the output gear, a fixed gear on the output shaft, which meshes both with a first output gear as either a shiftable or non-shiftable constant pinion of the first countershaft and also with a second output gear as a shiftable constant pinion of the second countershaft. Thus at least one of the output gears is designed as a shiftable gear. To shift the output gear, there may be assigned for example to at least one output gear a coupling device, which in its disengaged state releases the connection between the assigned countershaft and the output gear, in order to be able to shift winding path gears.

Advantageously, the lower forward gears and the reverse gears can be actuated by means of a start-up clutch or shifting clutch, in order to thereby concentrate higher loads on this clutch so that the second clutch can be designed for smaller construction space and lower cost. In particular, the gear planes can be situated in the proposed double clutch transmission so that the vehicle can be set in motion either by means of the inner transmission input shaft or of the outer transmission input shaft, and thus by means of whichever clutch is better suited in the particular case; this is also possible with a concentrically arranged, radially nested construction of the double clutch. Furthermore, the gear planes may be correspondingly arranged mirror-symmetrically, or may be exchanged.

Independent of the particular variant embodiment, in the double clutch transmission the provided gear planes may for example be exchanged.

### BRIEF DESCRIPTION OF THE DRAWINGS

The present invention will be explained in greater detail below on the basis of the drawing. The figures show the following:

FIG. 1 a schematic view of a first variant embodiment of an eight-speed double clutch transmission according to the invention;

FIG. 2 a shift pattern of the first variant embodiment according to FIG. 1;

FIG. 3 a schematic view of a second variant embodiment of the eight-speed double clutch transmission according to the invention;

FIG. 4 a shift pattern of the second variant embodiment according to FIG. 3;

FIG. 5 a schematic view of a third variant embodiment of the eight-speed double clutch transmission according to the invention;

FIG. 6 a shift pattern of the third variant embodiment according to FIG. 5;

FIG. 7 a schematic view of a fourth variant embodiment of the eight-speed double clutch transmission according to the invention;

FIG. 8 a shift pattern of the fourth variant embodiment according to FIG. 7;

FIG. 9 a schematic view of a fifth variant embodiment of the eight-speed double clutch transmission according to the invention;

FIG. 10 a shift pattern of the fifth variant embodiment according to FIG. 9;

FIG. 11 a schematic view of a sixth variant embodiment of the eight-speed double clutch transmission according to the invention;

FIG. 12 a shift pattern of the sixth variant embodiment according to FIG. 11;

FIG. 13 a schematic view of a seventh variant embodiment of the eight-speed double clutch transmission according to the invention;

FIG. 14 a shift pattern of the seventh variant embodiment according to FIG. 13;

FIG. 15 a schematic view of an eighth variant embodiment of the eight-speed double clutch transmission according to the invention;

FIG. 16 a shift pattern of the eighth variant embodiment according to FIG. 15;

FIG. 17 a schematic view of a ninth variant embodiment of the eight-speed double clutch transmission according to the invention;

FIG. 18 a shift pattern of the ninth variant embodiment according to FIG. 17;

FIG. 19 a schematic view of a tenth variant embodiment of the eight-speed double clutch transmission according to the invention; and

FIG. 20 a shift pattern of the tenth variant embodiment according to FIG. 19.

### DETAILED DESCRIPTION OF THE PREFERRED EMBODIMENTS

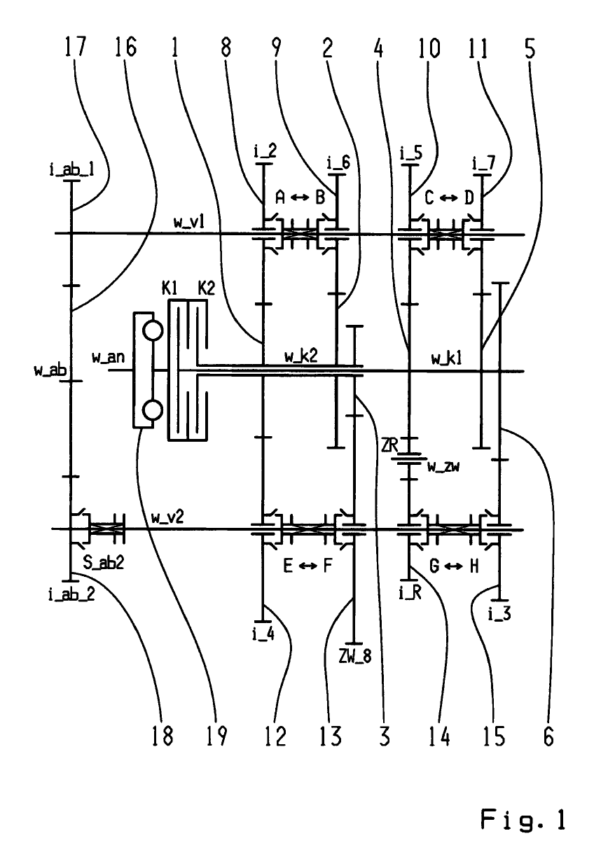

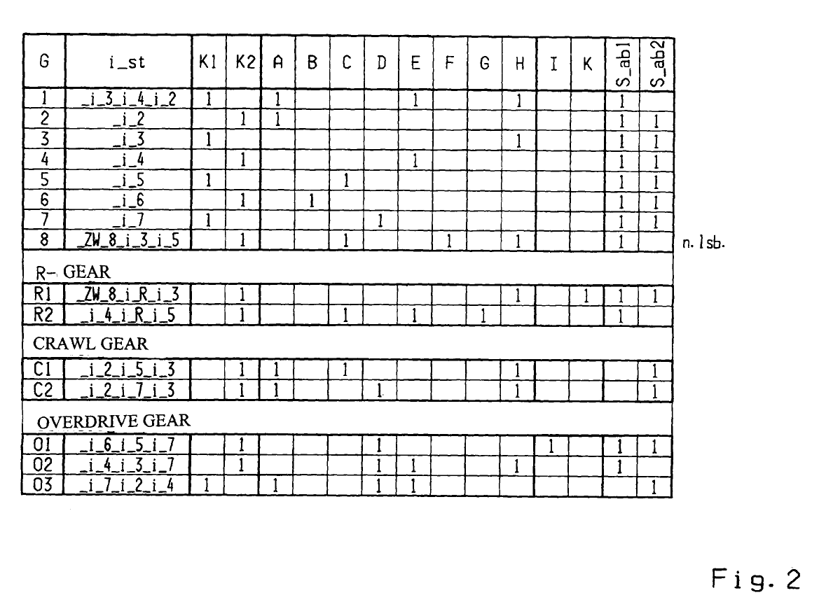

FIGS. 1, 3, 5, 7, 9, 11, 13, 15, 17, and 19 each show a possible variant embodiment of an eight-speed double clutch transmission. The respective shift patterns for the different variant embodiments are depicted in chart form in FIGS. 2, 4, 6, 8, 10, 12, 14, 16, 18 and 20.

The eight-speed double clutch transmission comprises two clutches K1, K2, whose input sides are connected to a driveshaft w_an and whose output sides are each connected to one of two transmission input shafts w_k1, w_k2 which are positioned coaxially with each other. In addition, a torsion vibration damper 19 can be placed on the driveshaft w_an. Furthermore, two countershafts w_v1, w_v2 are provided, on which toothed gear wheels in the form of idler gears 8, 9, 10, 11, 12, 13, 14, 15 are rotatably supported. Placed on the two transmission input shafts w_k1, w_k2 are rotationally fixed toothed gearwheels in the form of fixed gears 1, 2, 3, 4, 5, 6, at least part of which mesh with the idler gears 8, 9, 10, 11, 12, 13, 14, 15.

In order to be able to connect the idler gears 8, 9, 10, 11, 12, 13, 14, 15 with the respective countershaft w_v1, w_v2, a plurality of activatable coupling devices A, B, C, D, E, F, G, H are provided on the countershafts w_v1, w_v2. Furthermore, output gears 17, 18, each of which is coupled with toothing of a fixed gear 16 of an output shaft w_ab, with corresponding output stages i_ab_1, i_ab_2 assigned to the output gears 17, 18, are situated on the two countershafts w_v1, w_v2 as constant pinions.

Besides coupling devices A, B, C, D, E, F, G, H, which in the activated state realize a rotationally fixed connection between a toothed gearwheel and the assigned countershaft w_v1, w_v2, a winding path gear coupling device S_ab2 is assigned to output stage i_ab2 on second countershaft w_v2. When coupling device S_ab2 is disengaged, the rotationally fixed connection between output gear 18 and second countershaft w_v2 can be released. It is possible, in addition, for another winding path gear coupling device S_ab1 on first countershaft w_v1 to be assigned to output stage i_ab1 or to output gear 17. In the double clutch transmission, at least one winding path gear shift element I, K may be provided to connect two toothed gearwheels of a countershaft w_v1, w_v2 in a rotationally fixed connection, so that at least one winding path gear may also be realized through the activated shift elements I, K.

According to the invention, a maximum of six gear planes 1-12, 8-12, 9-2, 9-13, 3-13, 10-3, 10-4, 10-14, 4-14, 11-4, 5-14, 11-5, 11-15, 5-15, 6-15 are provided in the double clutch transmission, there being at least two dual gear planes 8-12, 9-13, 10-14, 11-15 provided in each variant embodiment, so that winding path gears are shiftable at least when coupling device S_ab2 is disengaged, and additionally by means of at least one of the activated shift elements I, K. A claw or the like, for example, for connecting two gearwheels or the like may be used as each of the shift elements I, K.

Shift element K, if present, is positioned on second countershaft w_v2, in order to be able to connect idler gear 13 with idler gear 14 when shift element K is activated. Shift element I, if present, is provided on first countershaft w_v1 in order to be able to connect idler gear 9 with idler gear 10 when shift element I is activated.

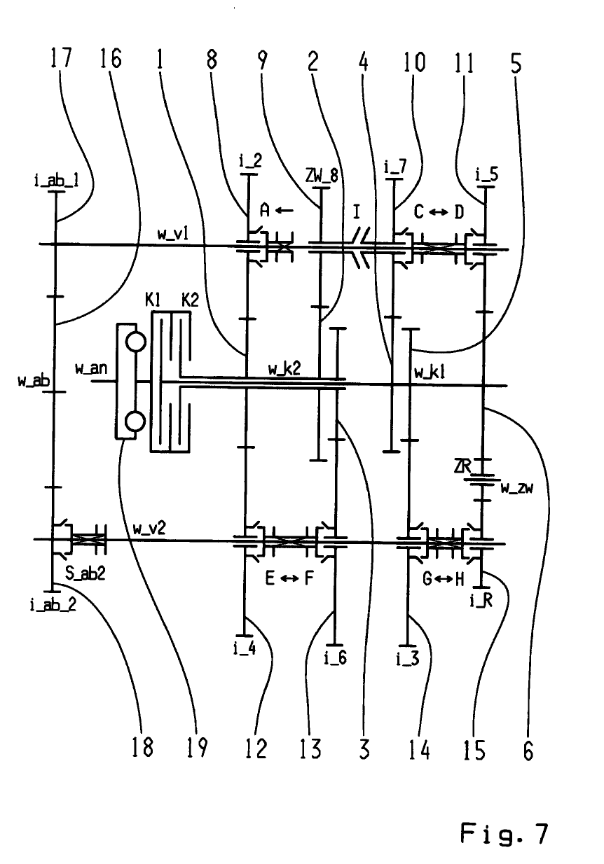

In the 1st and 4th variant embodiments according to FIGS. 1 and 7, with first gear plane 8-12 as a dual gear plane, fixed gear 1 of second transmission input shaft w_k2 meshes both with idler gear 8 of first countershaft w_v1 and also with idler gear 12 of second countershaft w_v2. In second gear plane 9-2, as a single gear plane, fixed gear 2 of second transmission input shaft w_k2 meshes with idler gear 9 of first countershaft w_v1. In third gear plane 3-13, as a single gear plane, fixed gear 3 of second transmission input shaft w_k2 meshes with idler gear 13 of second countershaft w_v2. In the first variant embodiment, in fourth gear plane 10-14 as a dual gear plane, fixed gear 4 of first transmission input shaft w_k1 meshes both with idler gear 10 of first countershaft w_v1 and also with an intermediate gear ZR on an intermediate shaft w_zw to reverse the rotation, in order to realize reverse gear transmission ratios, with intermediate gear ZR meshing with idler gear 14 of second countershaft w_v2. In fifth gear plane 11-5, as a single gear plane, fixed gear 5 of first transmission input shaft w_k1 meshes with idler gear 11 of first countershaft w_v1. Finally, in sixth gear plane 6-15, as a single gear plane, fixed gear 6 meshes with idler gear 15 of second countershaft w_v2. In the fourth variant embodiment, in fourth gear plane 10-4, as a single gear plane, fixed gear 4 of first transmission input shaft w_k1 meshes with idler gear 10 of first countershaft w_v1. In fifth gear plane 5-14, as a single gear plane, fixed gear 5 of first transmission input shaft w_k1 meshes with idler gear 14 of second countershaft w_v2. Finally, in sixth gear plane 11-15 as a dual gear plane, fixed gear 6 of first transmission input shaft w_k1 meshes both with idler gear 11 of first countershaft w_v1 and also with intermediate gear ZR on intermediate shaft w_zw to reverse the rotation for the reverse gear transmission ratios, with intermediate gear ZR meshing with idler gear 15 of second countershaft w_v2.

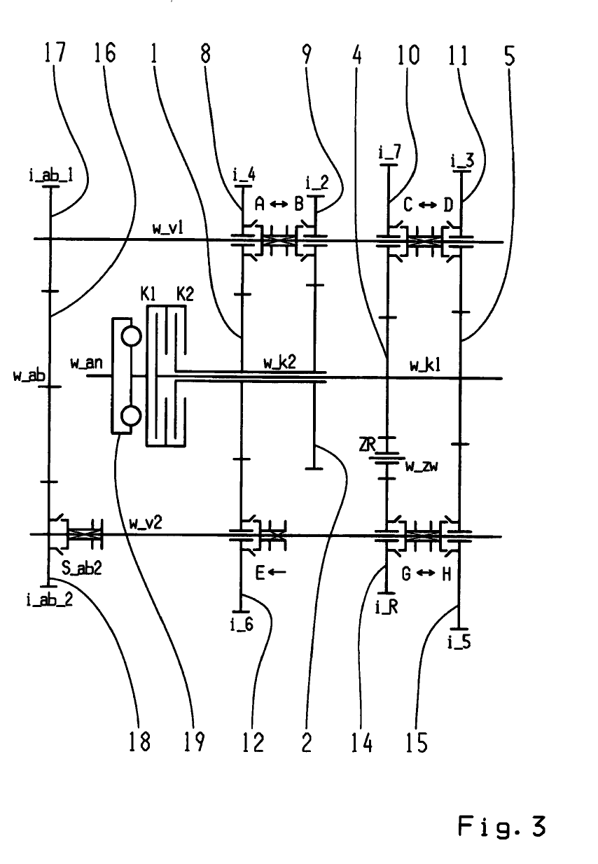

In the 2nd variant embodiment according to FIG. 3, in first gear plane 8-12 as a dual gear plane, fixed gear 1 of second transmission input shaft w_k2 meshes both with idler gear 8 of first countershaft w_v1 and also with idler gear 12 of second countershaft w_v2. In second gear plane 9-2, as a single gear plane, fixed gear 2 of second transmission input shaft w_k2 meshes with idler gear 9 of first countershaft w_v1. In third gear plane 10-14, as a dual gear plane, fixed gear 4 of first transmission input shaft w_k1 meshes both with idler gear 10 of first countershaft w_v1 and also with intermediate gear ZR for reversing the rotation for the reverse gear transmission ratios, with intermediate gear ZR also meshing with idler gear 14 of second countershaft w_v2. Finally in fourth gear plane 11-15 as a dual gear plane, fixed gear 5 of first transmission input shaft w_k1 meshes both with idler gear 11 of first countershaft w_v1 and also with idler gear 15 of second countershaft w_v2.

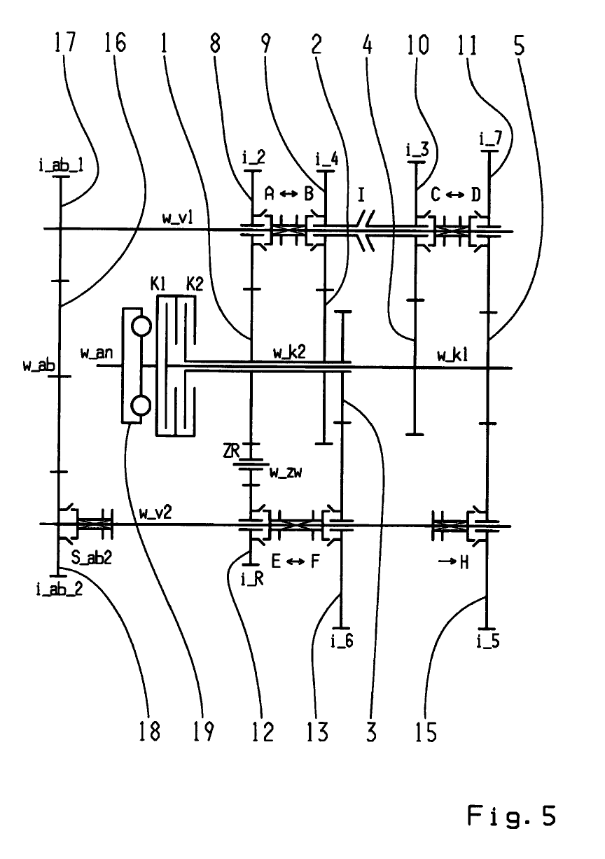

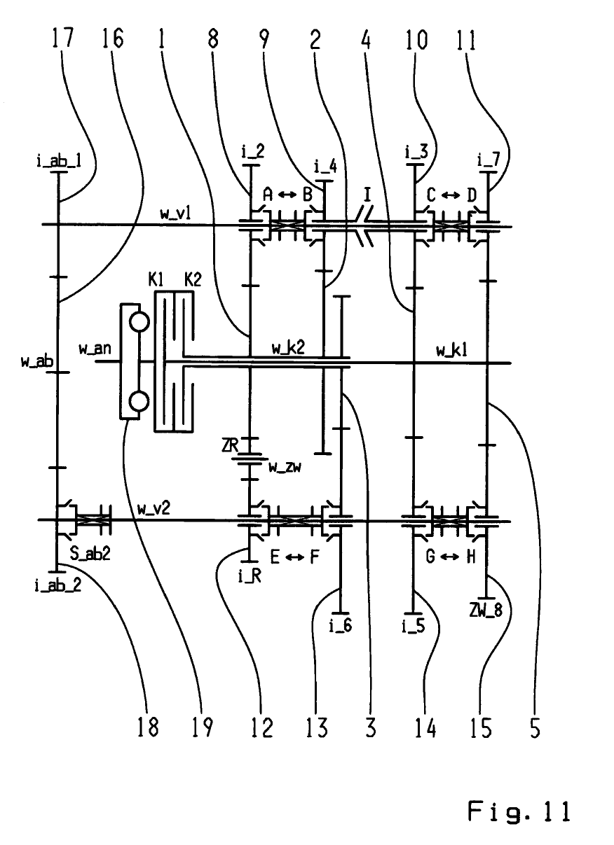

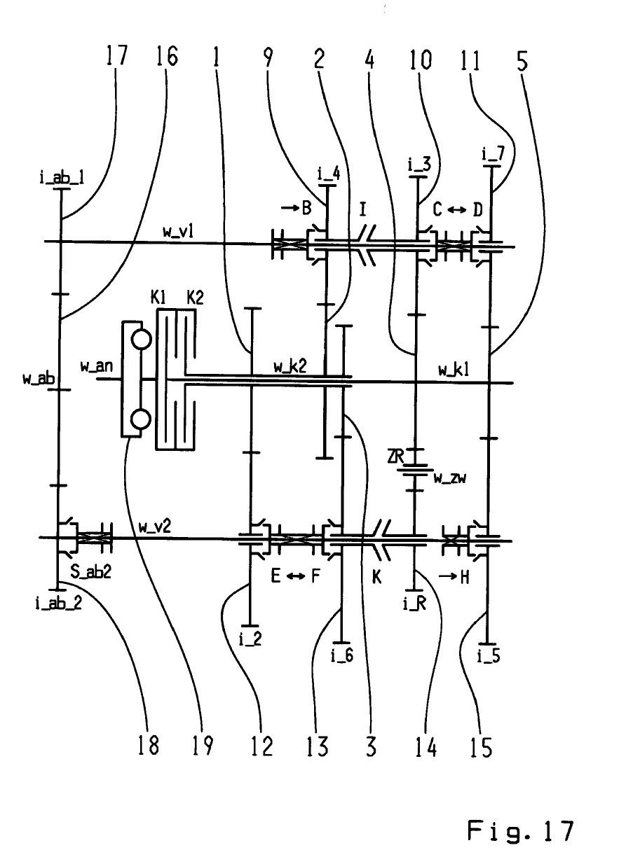

In the 3rd and 6th variant embodiments according to FIGS. 5 and 11, in first gear plane 8-12, as a dual gear plane, fixed gear 1 of second transmission input shaft w_k2 meshes both with idler gear 8 of first countershaft w_v1 and also with intermediate gear ZW for reversing the rotation for the reverse gear transmission ratios, with intermediate gear ZR meshing with idler gear 12 of second countershaft w_v2. In contrast, in the ninth variant embodiment according to FIG. 17, in first gear plane 1-12, as a single gear plane, fixed gear 1 of second transmission input shaft w_k2 meshes with idler gear 12 of second countershaft w_v2.

In the 3rd, 6th and 9th variant embodiments, in second gear plane 9-2, as a single gear plane, fixed gear 2 of second transmission input shaft w_k2 meshes with idler gear 9 of first countershaft w_v1. In third gear plane 3-13, as a single gear plane, fixed gear 3 of second transmission input shaft w_k2 meshes with idler gear 13 of second countershaft w_v2. In the 3rd variant embodiment, in fourth gear plane 10-4, as a single gear plane, fixed gear 4 of first transmission input shaft w_k1 meshes with idler gear 10 of first countershaft w_v1. In the 6th and 9th variant embodiments, in fourth gear plane 10-14, as a dual gear plane, fixed gear 4 of first transmission input shaft w_k1 meshes both with idler gear 10 of first countershaft w_v1 and also with idler gear 14 of second countershaft w_v2; in the 9th variant embodiment, fixed gear 4 is coupled with idler gear 14 through intermediate gear ZR to reverse rotation.

In the 3rd, 6th and 9th variant embodiments, in gear plane 11-15, as a dual gear plane, fixed gear 5 of first transmission input shaft w_k1 meshes both with idler gear 11 of first countershaft w_v1 and also with idler gear 15 of second countershaft w_v2.

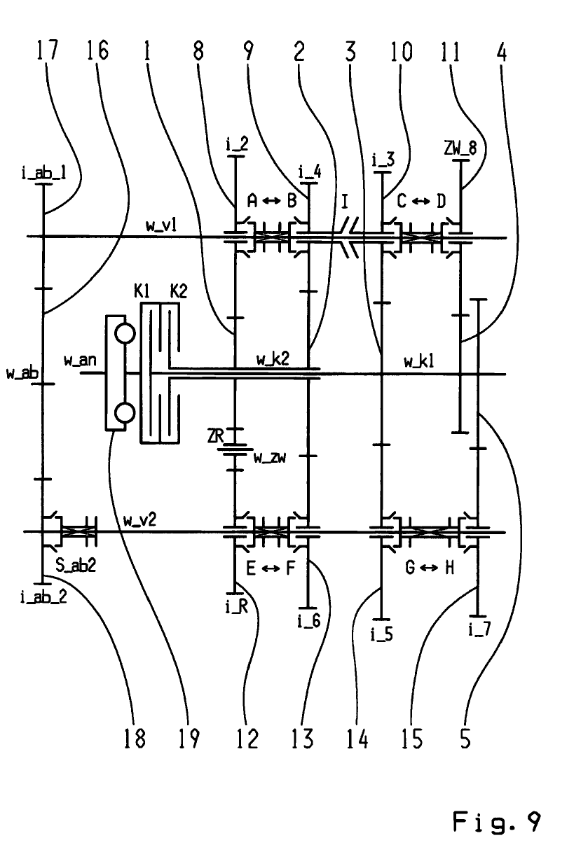

In the 5th variant embodiment according to FIG. 9, in first gear plane 8-12, as a dual gear plane, fixed gear 1 of second transmission input shaft w_k2 meshes both with idler gear 8 of first countershaft w_v1 and also with intermediate gear ZW for reversing the rotation for the reverse gear transmission ratios, with intermediate gear ZR meshing with idler gear 12 of second countershaft w_v2. In second gear plane 9-13, as a dual gear plane, fixed gear 2 of second transmission input shaft w_k2 meshes both with idler gear 9 of first countershaft w_v1 and also with idler gear 13 of second countershaft w_v2. In third gear plane 10-14, as a dual gear plane, fixed gear 3 of first transmission input shaft w_k1 meshes both with idler gear 10 of first countershaft w_v1 and also with idler gear 14 of second countershaft w_v2. In fourth gear plane 11-4, as a single gear plane, fixed gear 4 of first transmission input shaft w_k1 meshes with idler gear 11 of first countershaft w_v1. Finally, in fifth gear plane 5-15, as a single gear plane, fixed gear 5 of first transmission input shaft w_k1 meshes with idler gear 15 of second countershaft w_v2.

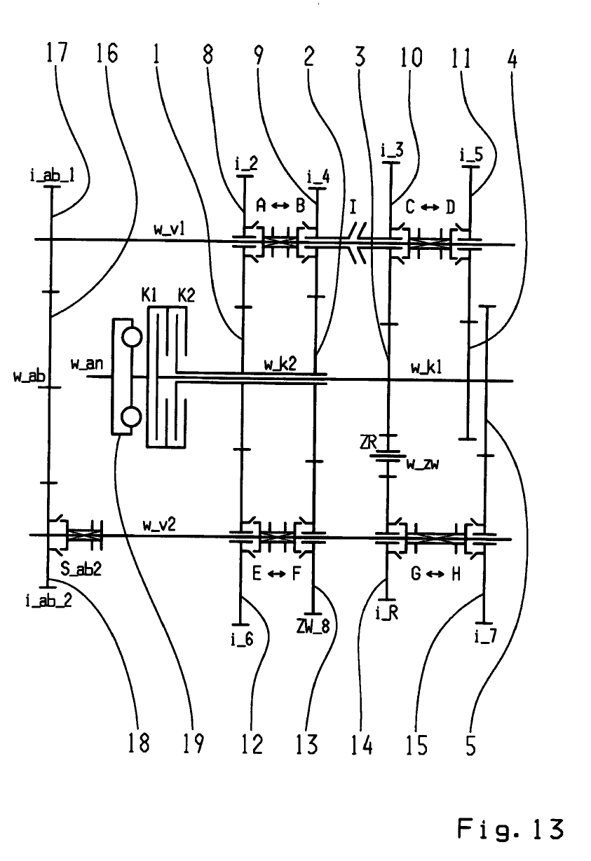

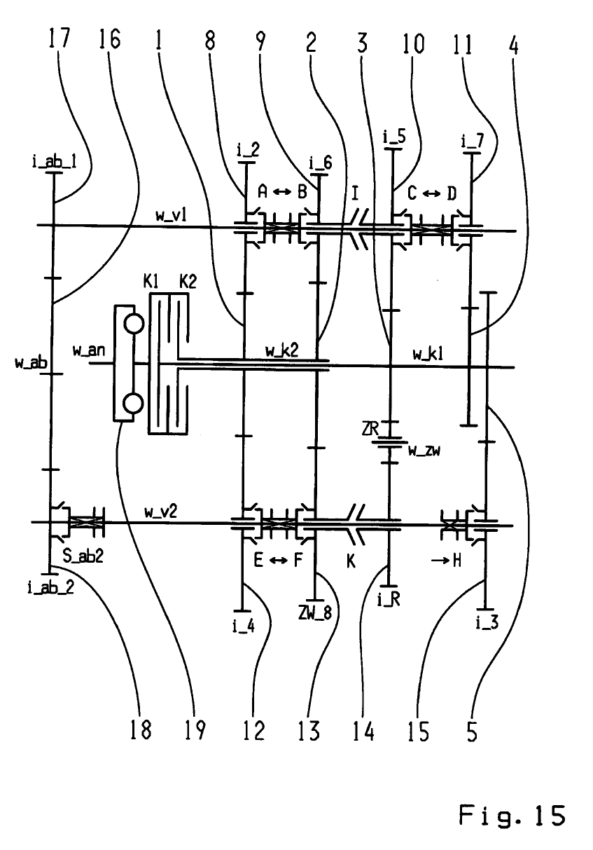

In the 7th and 8th variant embodiments according to FIGS. 13 and 15, in first gear plane 8-12, as a dual gear plane, fixed gear 1 of second transmission input shaft w_k2 meshes both with idler gear 8 of first countershaft w_v1 and also with idler gear 12 of second countershaft w_v2. In second gear plane 9-13, as a dual gear plane, fixed gear 2 of second transmission input shaft w_k2 meshes both with idler gear 9 of first countershaft w_v1 and also with idler gear 13 of second countershaft w_v2. In third gear plane 10-14, as a dual gear plane, fixed gear 3 of first transmission input shaft w_k1 meshes both with idler gear 10 of first countershaft w_v1 and also with intermediate gear ZR for reversing the rotation for the reverse gear transmission ratios, with intermediate gear ZR also meshing with idler gear 14 of second countershaft w_v2. In fourth gear plane 11-4, as a single gear plane, fixed gear 4 of first transmission input shaft w_k1 meshes with idler gear 11 of first countershaft w_v1. In fifth gear plane 5-15, as a single gear plane, fixed gear 5 of first transmission input shaft w_k1 meshes with idler gear 15 of second countershaft w_v2.

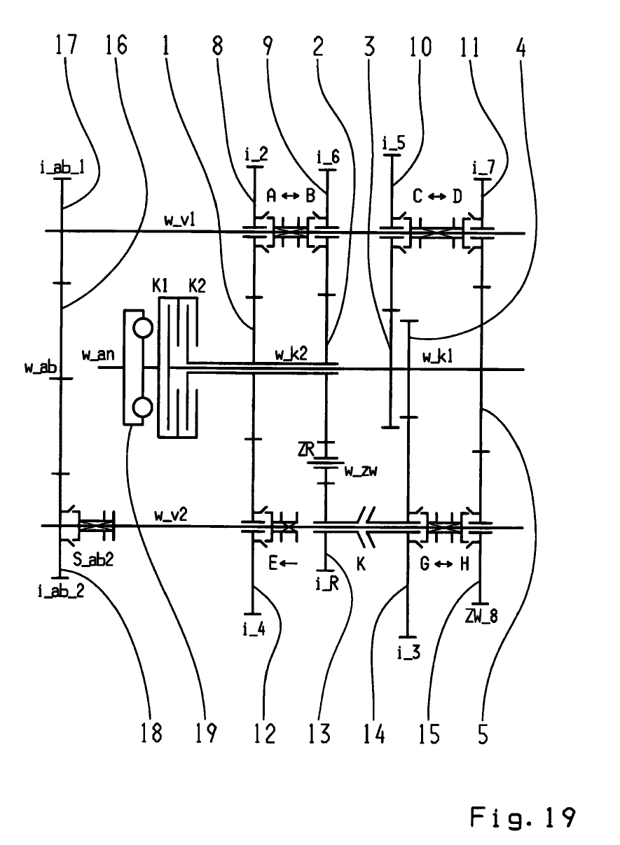

In the 10th variant embodiment according to FIG. 19, in first gear plane 8-12, as a dual gear plane, fixed gear 1 of second transmission input shaft w_k2 meshes both with idler gear 8 of first countershaft w_v1 and also with idler gear 12 of second countershaft w_v2. In second gear plane 9-13, as a dual gear plane, fixed gear 2 of second transmission input shaft w_k2 meshes both with idler gear 9 of first countershaft w_v1 and also with intermediate gear ZR for reversing the rotation for the reverse gear transmission ratios, with intermediate gear ZR also meshing with idler gear 13 of second countershaft w_v2. In third gear plane 10-3, as a single gear plane, fixed gear 3 of first transmission input shaft w_k1 meshes with idler gear 10 of first countershaft w_v1. In fourth gear plane 4-14, as a single gear plane, fixed gear 4 of first transmission input shaft w_k1 meshes with idler gear 14 of second countershaft w_v2. In fifth gear plane 11-15, as a dual gear plane, fixed gear 5 of first transmission input shaft w_k1 meshes both with idler gear 11 of first countershaft w_v1 and also with idler gear 15 of second countershaft w_v2.

In the 1st, 2nd, 3rd, 5th, 6th, 7th, 8th and 10th variant embodiments according to FIGS. 1, 3, 5, 9, 11, 13, 15 and 19, in each case two doubly operative coupling devices A-B and C-D are provided on the first countershaft w_v1, the coupling devices A-B and C-D being arranged so that the activated coupling device A firmly connects idler gear 8, the activated coupling device B firmly connects idler gear 9, the activated coupling device C firmly connects idler gear 10 and the activated coupling device D firmly connects idler gear 11, in each case to first countershaft w_v1.

In the 4th and 9th variant embodiments according to FIGS. 7 and 17, in each case a singly operative coupling device A or B and in each case a doubly operative coupling device C-D are provided on the first countershaft w_v1, the coupling devices A, B, C-D being arranged so that the activated coupling device A firmly connects idler gear 8, the activated coupling device B firmly connects idler gear 9, the activated coupling device C firmly connects idler gear 10 and the activated coupling device D firmly connects idler gear 11, in each case to first countershaft w_v1.

In the 1st, 4th, 5th, 6th and 7th variant embodiments according to FIGS. 1, 7, 9, 11 and 13, in each case there are two doubly operative coupling devices E-F and G-H assigned to the second countershaft w_v2, the coupling devices E-F and G-H being arranged so that the activated coupling device E firmly connects idler gear 12, the activated coupling device F firmly connects idler gear 13, the activated coupling device G firmly connects idler gear 14 and the activated coupling device H firmly connects idler gear 15, in each case to second countershaft w_v2.

In the 2nd, 3rd, 8th, 9th and 10th variant embodiments according to FIGS. 3, 5, 15, 17 and 19, in each case a singly operative coupling device E or H and in each case a doubly operative coupling device E-F and G-H are assigned to the second countershaft w_v2, the coupling devices E, H, E-F and G-H being arranged so that the activated coupling device E firmly connects idler gear 12, the activated coupling device F firmly connects idler gear 13, the activated coupling device G firmly connects idler gear 14 and the activated coupling device H firmly connects idler gear 15, in each case to second countershaft w_v2.

Independent of the particular variant embodiments, an integrated output stage with the output gear 17 and with the output gear 18 is provided in the double clutch transmission according to the invention. Output gear 17 and output gear 18 each mesh with a fixed gear 16 of output shaft w_ab. Preferably, at least one shiftable connection is realized between output gear 18 and the assigned countershaft w_v2 by the shiftable coupling device S_ab2.

Furthermore, it turns out in the case of the double clutch transmission according to the invention that at least the forward gears G1 through G7 can be designed so that they are power shiftable. In addition, depending on the variant embodiment, the eighth forward gear G8, reverse gears and/or crawler gears and/or overdrive gears, for example, can also be designed to be power shiftable as winding path gears. Details for each variant embodiment will be evident from the shift patterns described below.

The table depicted in FIG. 2 shows an example of a shift pattern for the 1st variant embodiment of the eight-speed double clutch transmission according to FIG. 1.

It is evident from the shift pattern that the first forward gear G1 is shiftable by means of the first clutch K1, the activated coupling device A, the activated coupling device E and the activated coupling device H, and also as a winding path gear when coupling device S_ab2 is disengaged, that the second forward gear G2 is shiftable by means of the second clutch K2 and the activated coupling device A, that the third forward gear G3 is shiftable by means of the first clutch K1 and the activated coupling device H, that the fourth forward gear G4 is shiftable by means of the second clutch K2 and the activated coupling device E, that the fifth forward gear G5 is shiftable by means of the first clutch K1 and the activated coupling device C, that the sixth forward gear G6 is shiftable by means of the second clutch K2 and the activated coupling device B, and that the seventh forward gear G7 is shiftable by means of the first clutch K1 and the activated coupling device D. Thus, at least the first seven forward gears can be designed to be power shiftable. Furthermore, the eighth forward gear G8 can be shifted by means of the second clutch K2, the activated coupling device C, the activated coupling device F and the activated coupling device H, and also as a winding path gear when coupling device S_ab2 is disengaged.

In addition, in the 1st variant embodiment a reverse gear R1 can be shifted by means of the second clutch K2 and the activated coupling device H, and also as a winding path gear by means of the activated shift element K, and/or a reverse gear R2 can be shifted by means of the second clutch K2, the activated coupling device C, the activated coupling device E and the activated coupling device G, and also as a winding path gear when coupling device S_ab2 is disengaged.

Finally, a crawler gear C1 can be shifted by means of the second clutch K2, the activated coupling device A, the activated coupling device C and the activated coupling device H, and also as a winding path gear when a coupling device S_ab1 is disengaged, and/or a crawler gear C2 can be shifted by means of the second clutch K2, the activated coupling device A, the activated coupling device D and the activated coupling device H, and also as a winding path gear when a coupling device S_ab1 is disengaged.

Finally, an overdrive gear O1 can be shifted by means of the second clutch K2 and the activated coupling device D, and also as a winding path gear by means of the activated shift element I, and/or an overdrive gear O2 can be shifted by means of the second clutch K2, the activated coupling device D, the activated coupling device E and the activated coupling device H, and also as a winding path gear when coupling device S_ab2 is disengaged, and/or an overdrive gear O3 can be shifted by means of the first clutch K1, the activated coupling device A, the activated coupling device D and the activated coupling device E, and also as a winding path gear when a coupling device S_ab1 is disengaged.

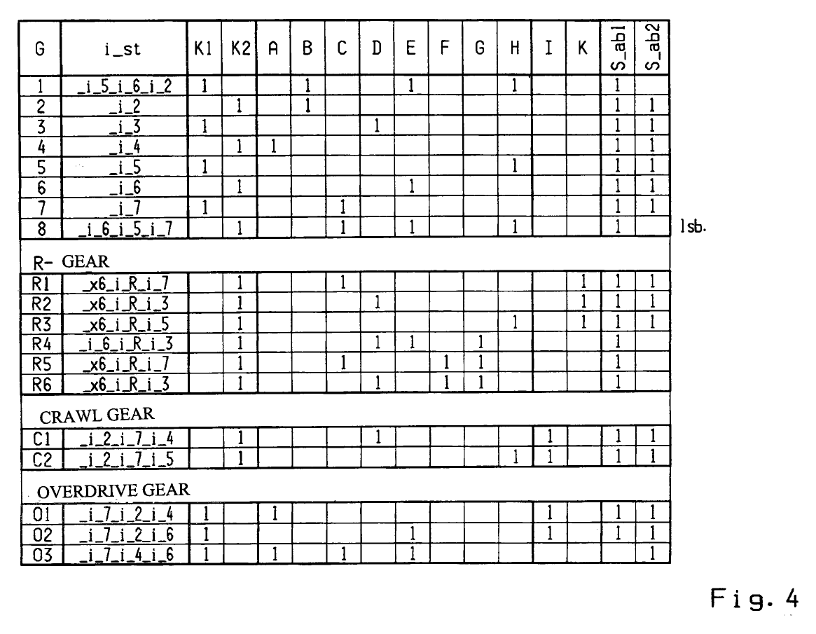

The table depicted in FIG. 4 shows an example of a shift pattern for the 2nd variant embodiment of the eight-speed double clutch transmission according to FIG. 3.

It is evident from the shift pattern that the first forward gear G1 is shiftable by means of the first clutch K1, the activated coupling device B, the activated coupling device E and the activated coupling device H, and also as a winding path gear when coupling device S_ab2 is disengaged, that the second forward gear G2 is shiftable by means of the second clutch K2 and the activated coupling device B, that the third forward gear G3 is shiftable by means of the first clutch K1 and the activated coupling device D, that the fourth forward gear G4 is shiftable by means of the second clutch K2 and the activated coupling device A, that the fifth forward gear G5 is shiftable by means of the first clutch K1 and the activated coupling device H, that the sixth forward gear G6 is shiftable by means of the second clutch K2 and the activated coupling device E, that the seventh forward gear G7 is shiftable by means of the first clutch K1 and the activated coupling device C, and that the eighth forward gear G8 is shiftable by means of the second clutch K2, the activated coupling device C, the activated coupling device E and the activated coupling device H, and also as a winding path gear when coupling device S_ab2 is disengaged. Thus, at least the first eight forward gears can be designed to be power shiftable.

Moreover, for example a reverse gear R1 can be shifted by means of the second clutch K2 and the activated coupling device C and also as a winding path gear by means of the activated shift element K, and/or a reverse gear R2 can be shifted by means of the second clutch K2 and the activated coupling device D and also as a winding path gear by means of the activated shift element K, and/or a reverse gear R3 can be shifted by means of the second clutch K2 and the activated coupling device H and also as a winding path gear by means of the activated shift element K, and/or a reverse gear R4 can be shifted by means of the second clutch K2, the activated coupling device D, the activated coupling device E and the activated coupling device G and also as a winding path gear when coupling S_ab2 is disengaged, and/or a reverse gear R5 can be shifted by means of the second clutch K2, the activated coupling device C, the activated coupling device F and the activated coupling device G, and also as a winding path gear when coupling device S_ab2 is disengaged, and/or a reverse gear R6 can be shifted by means of the second clutch K2, the activated coupling device D, the activated coupling device F and the activated coupling device G, and also as a winding path gear when coupling device S_ab2 is disengaged.

Furthermore, a crawler gear C1 can be shifted by means of the second clutch K2 and the activated coupling device D, and also as a winding path gear by means of the activated shift element I, and/or a crawler gear C2 can be shifted by means of the second clutch K2 and the activated coupling device H, and also as a winding path gear by means of the activated shift element I.

Finally, an overdrive gear O1 can be shifted by means of the first clutch K1 and the activated coupling device A, and also as a winding path gear by means of the activated shift element I, and/or an overdrive gear O2 can be shifted by means of the first clutch K1 and the activated coupling device E and also as a winding path gear by means of the activated shift element I, and/or an overdrive gear O3 can be shifted by means of the first clutch K1, the activated coupling device A, the activated coupling device C and the activated coupling device E, and also as a winding path gear when a coupling device S_ab1 is disengaged.

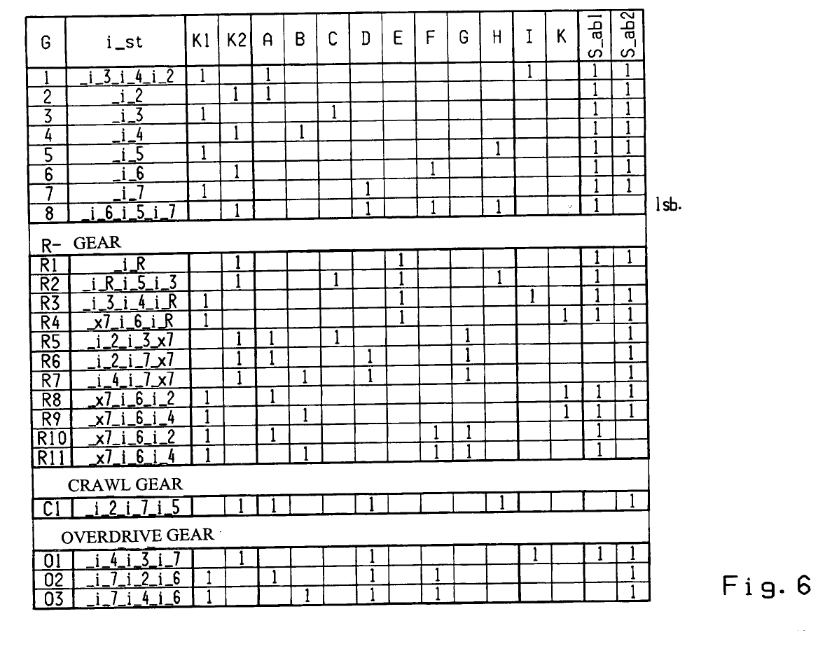

The table depicted in FIG. 6 shows an example of a shift pattern for the 3rd variant embodiment of the eight-speed double clutch transmission according to FIG. 5.

It is evident from the shift pattern that the first forward gear O1 is shiftable by means of the first clutch K1 and the activated coupling device A, and also as a winding path gear by means of the activated shift element I, that the second forward gear G2 is shiftable by means of the second clutch K2 and the activated coupling device A, that the third forward gear G3 is shiftable by means of the first clutch K1 and the activated coupling device C, that the fourth forward gear G4 is shiftable by means of the second clutch K2 and the activated coupling device B, that the fifth forward gear G5 is shiftable by means of the first clutch K1 and the activated coupling device H, that the sixth forward gear G6 is shiftable by means of the second clutch K2 and the activated coupling device F, that the seventh forward gear G7 is shiftable by means of the first clutch K1 and the activated coupling device D, and that the eighth forward gear G8 is shiftable by means of the second clutch K2, the activated coupling device D, the activated coupling device F and the activated coupling device H, and also as a winding path gear when coupling device S_ab2 is disengaged. Thus, at least the first eight forward gears can be designed to be power shiftable.

Furthermore, a reverse gear R1 can be shifted by means of the second clutch K2 and the activated coupling device E, and/or a reverse gear R2 can be shifted by means of the second clutch K2, the activated coupling device C, the activated coupling device E and the activated coupling device H, and also as a winding path gear when coupling device S_ab2 is disengaged, and/or a reverse gear R3 can be shifted by means of the first clutch K1 and the activated coupling device E, and also as a winding path gear by means of the activated shift element I, and/or a reverse gear R4 can be shifted by means of the first clutch K1 and the activated coupling device E, and also as a winding path gear by means of the activated shift element K, and/or a reverse gear R5 can be shifted by means of the second clutch K2, the activated coupling device A, the activated coupling device C and the activated coupling device G, and also as a winding path gear when a coupling device S_ab1 is disengaged, and/or a reverse gear R6 can be shifted by means of the second clutch K2, the activated coupling device A, the activated coupling device D and the activated coupling device G, and also as a winding path gear when a coupling device S_ab1 is disengaged, and/or a reverse gear R7 can be shifted by means of the second clutch K2, the activated coupling device B, the activated coupling device D and the activated coupling device G, and also as a winding path gear when a coupling device S_ab1 is disengaged, and/or a reverse gear R8 can be shifted by means of the first clutch K1 and the activated coupling device A, and also as a winding path gear by means of the activated shift element K, and/or a reverse gear R9 can be shifted by means of the first clutch K1 and the activated coupling device B, and also as a winding path gear by means of the activated shift element K, and/or a reverse gear R10 can be shifted by means of the first clutch K1, the activated coupling device A, the activated coupling device F and the activated coupling device G, and also as a winding path gear when coupling device S_ab2 is disengaged, and/or a reverse gear R11 can be shifted by means of the first clutch K1, the activated coupling device B, the activated coupling device F and the activated coupling device G, and also as a winding path gear when coupling device S_ab2 is disengaged.

Furthermore, in the 3rd variant embodiment for example a crawler gear C1 can be shifted by means of the second clutch K2, the activated coupling device A, the activated coupling device D and the activated coupling device H, and also as a winding path gear when a coupling device S_ab1 is disengaged.

Finally, an overdrive gear O1 can be shifted by means of the second clutch K2 and the activated coupling device D, and also as a winding path gear by means of the activated shift element I, and/or an overdrive gear O2 can be shifted by means of the first clutch K1, the activated coupling device A, the activated coupling device D and the activated coupling device F, and also as a winding path gear when a coupling device S_ab1 is disengaged, and/or an overdrive gear O3 can be shifted by means of the first clutch K1, the activated coupling device B, the activated coupling device D and the activated coupling device F, and also as a winding path gear when a coupling device S_ab1 is disengaged.

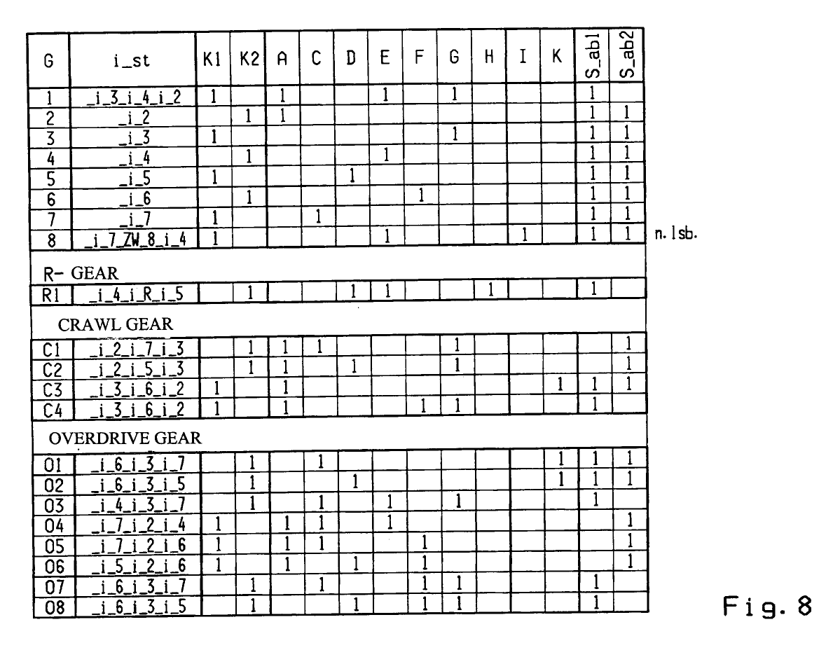

The table depicted in FIG. 8 shows an example of a shift pattern for the 4th variant embodiment of the eight-speed double clutch transmission according to FIG. 7

It is evident from the shift pattern that the first forward gear G1 is shiftable by means of the first clutch K1, the activated coupling device A, the activated coupling device E and the activated coupling device G, and also as a winding path gear when coupling device S_ab2 is disengaged, that the second forward gear G2 is shiftable by means of the second clutch K2 and the activated coupling device A, that the third forward gear G3 is shiftable by means of the first clutch K1 and the activated coupling device G, that the fourth forward gear G4 is shiftable by means of the second clutch K2 and the activated coupling device E, that the fifth forward gear G5 is shiftable by means of the first clutch K1 and the activated coupling device D, that the sixth forward gear G6 is shiftable by means of the second clutch K2 and the activated coupling device F, and that the seventh forward gear G7 is shiftable by means of the first clutch K1 and the activated coupling device C. Thus, at least the first seven forward gears can be designed to be power shiftable. Furthermore, the eighth forward gear G8 can be shifted by means of the first clutch K1 and the activated coupling device E, and also as a winding path gear by means of the activated shift element I.

Furthermore, a reverse gear R1 for example can be shifted by means of the second clutch K2, the activated coupling device D, the activated coupling device E and the activated coupling device H, and also as a winding path gear when coupling device S_ab2 is disengaged.

Furthermore, in the 4th variant embodiment a crawler gear C1 can be shifted by means of the second clutch K2, the activated coupling device A, the activated coupling device C and the activated coupling device G, and also as a winding path gear when a coupling device S_ab1 is disengaged, and/or a crawler gear C2 can be shifted by means of the second clutch K2, the activated coupling device A, the activated coupling device D and the activated coupling device G, and also as a winding path gear when a coupling device S_ab1 is disengaged, and/or a crawler gear C3 can be shifted by means of the first clutch K1 and the activated coupling device A, and also as a winding path gear by means of the activated shift element K, and/or a crawler gear C4 can be shifted by means of the first clutch K1, the activated coupling device A, the activated coupling device F and the activated coupling device G, and also as a winding path gear when coupling device S_ab2 is disengaged.

Finally, in the 4th variant embodiment an overdrive gear O1 can be shifted by means of the second clutch K2 the activated coupling device C, and also as a winding path gear by means of the activated shift element K, and/or an overdrive gear O2 can be shifted by means of the second clutch K2 and the activated coupling device D, and also as a winding path gear by means of the activated shift element K, and/or an overdrive gear O3 can be shifted by means of the second clutch K2, the activated coupling device C, the activated coupling device E and the activated coupling device G, and also as a winding path gear when coupling device S_ab2 is disengaged, and/or an overdrive gear O4 can be shifted by means of the first clutch K1, the activated coupling device A, the activated coupling device C and the activated coupling device E, and also as a winding path gear when a coupling device S_ab1 is disengaged, and/or an overdrive gear O5 can be shifted by means of the first clutch K1, the activated coupling device A, the activated coupling device C and the activated coupling device F, and also as a winding path gear when a coupling device S_ab1 is disengaged, and/or an overdrive gear O6 can be shifted by means of the first clutch K1, the activated coupling device A, the activated coupling device D and the activated coupling device F, and also as a winding path gear when a coupling device S_ab1 is disengaged, and/or an overdrive gear O7 can be shifted by means of the second clutch K2, the activated coupling device C, the activated coupling device F and the activated coupling device G, and also as a winding path gear when coupling device S_ab2 is disengaged, and/or an overdrive gear O8 can be shifted by means of the second clutch K2, the activated coupling device D, the activated coupling device F and the activated coupling device G, and also as a winding path gear when coupling device S_ab2 is disengaged.

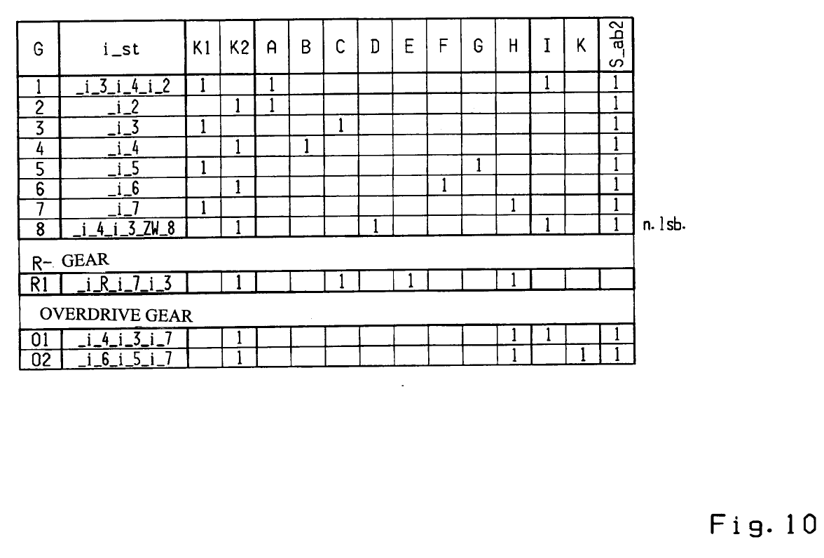

The table depicted in FIG. 10 shows an example of a shift pattern for the 5th variant embodiment of the eight-speed double clutch transmission according to FIG. 9.

It is evident from the shift pattern that the first forward gear G1 is shiftable by means of the first clutch K1 and the activated coupling device A, and also as a winding path gear by means of the activated shift element I, that the second forward gear G2 is shiftable by means of the second clutch K2 and the activated coupling device A, that the third forward gear G3 is shiftable by means of the first clutch K1 and the activated coupling device C, that the fourth forward gear G4 is shiftable by means of the second clutch K2 and the activated coupling device B, that the fifth forward gear G5 is shiftable by means of the first clutch K1 and the activated coupling device G, that the sixth forward gear G6 is shiftable by means of the second clutch K2 and the activated coupling device F, and that the seventh forward gear G7 is shiftable by means of the first clutch K1 and the activated coupling device H. Thus, at least the first seven forward gears can be designed to be power shiftable. Furthermore, the eighth forward gear G8 can be shifted by means of the second clutch K2 and the activated coupling device D, and also as a winding path gear by means of the activated shift element I.

Furthermore, in the 5th variant embodiment for example a reverse gear R1 can be shifted by means of the second clutch K2, the activated coupling device C, the activated coupling device E and the activated coupling device H, and also as a winding path gear when a coupling device S_ab2 is disengaged.

Furthermore, in the 5th variant embodiment an overdrive gear O1 can be shifted by means of the second clutch K2 and the activated coupling device H, and also as a winding path gear by means of the activated shift element I, and/or an overdrive gear O2 can be shifted by means of the second clutch K2 and the activated coupling device H, and also as a winding path gear by means of the activated shift element K.

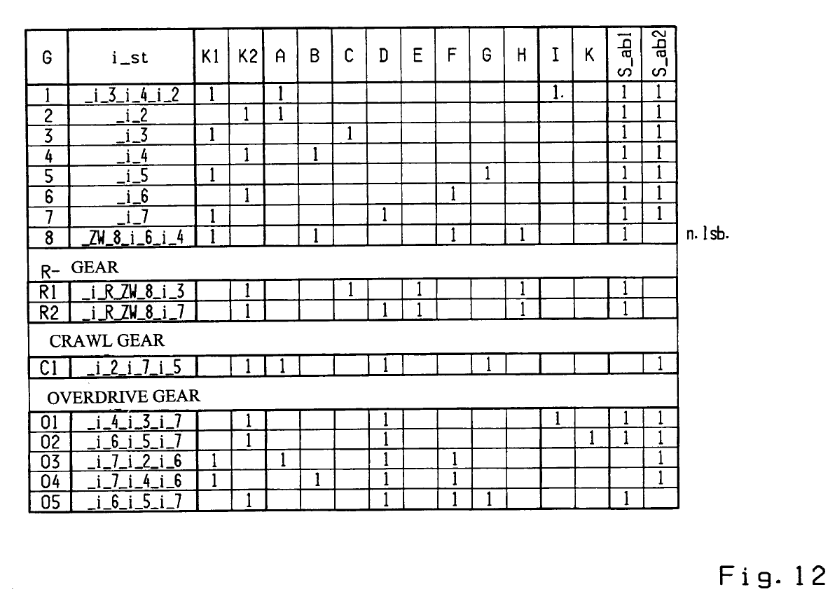

The table depicted in FIG. 12 shows an example of a shift pattern for the 6th variant embodiment of the eight-speed double clutch transmission according to FIG. 11.

It is evident from the shift pattern that the first forward gear G1 is shiftable by means of the first clutch K1 and the activated coupling device A, and also as a winding path gear by means of the activated shift element I, that the second forward gear G2 is shiftable by means of the second clutch K2 and the activated coupling device A, that the third forward gear G3 is shiftable by means of the first clutch K1 and the activated coupling device C, that the fourth forward gear G4 is shiftable by means of the second clutch K2 and the activated coupling device B, that the fifth forward gear G5 is shiftable by means of the first clutch K1 and the activated coupling device G, that the sixth forward gear G6 is shiftable by means of the second clutch K2 and the activated coupling device F, and that the seventh forward gear G7 is shiftable by means of the first clutch K1 and the activated coupling device D. Thus, at least the first seven forward gears can be designed to be power shiftable. Furthermore, the eighth forward gear G8 can be shifted by means of the first clutch K1, the activated coupling device B, the activated coupling device F and the activated coupling device H, and also as a winding path gear when coupling device S_ab2 is disengaged.

Moreover, a reverse gear R1 for example can be shifted by means of the second clutch K2, the activated coupling device C, the activated coupling device E and the activated coupling device H, and also as a winding path gear when coupling device S_ab2 is disengaged, and/or a reverse gear R2 can be shifted by means of the second clutch K2, the activated coupling device D, the activated coupling device E and the activated coupling device H, and also as a winding path gear when coupling device S_ab2 is disengaged.

Furthermore, in the 6th variant embodiment for example a crawler gear C1 can be shifted by means of the second clutch K2, the activated coupling device A, the activated coupling device D and the activated coupling device G, and also as a winding path gear when a coupling device S_ab1 is disengaged.

In addition, for example an overdrive gear O1 can be shifted by means of the second clutch K2 and the activated coupling device D, and also as a winding path gear by means of the activated shift element I, and/or an overdrive gear O2 can be shifted by means of the second clutch K2 and the activated coupling device D, and also as a winding path gear by means of the activated shift element K, and/or an overdrive gear O3 can be shifted by means of the first clutch K1, the activated coupling device A, the activated coupling device D and the activated coupling device F, and also as a winding path gear when a coupling device S_ab1 is disengaged, and/or an overdrive gear O4 can be shifted by means of the first clutch K1, the activated coupling device B, the activated coupling device D and the activated coupling device F, and also as a winding path gear when a coupling device S_ab1 is disengaged, and/or an overdrive gear O5 can be shifted by means of the second clutch K2, the activated coupling device D, the activated coupling device F and the activated coupling device G, and also as a winding path gear when coupling device S_ab2 is disengaged.

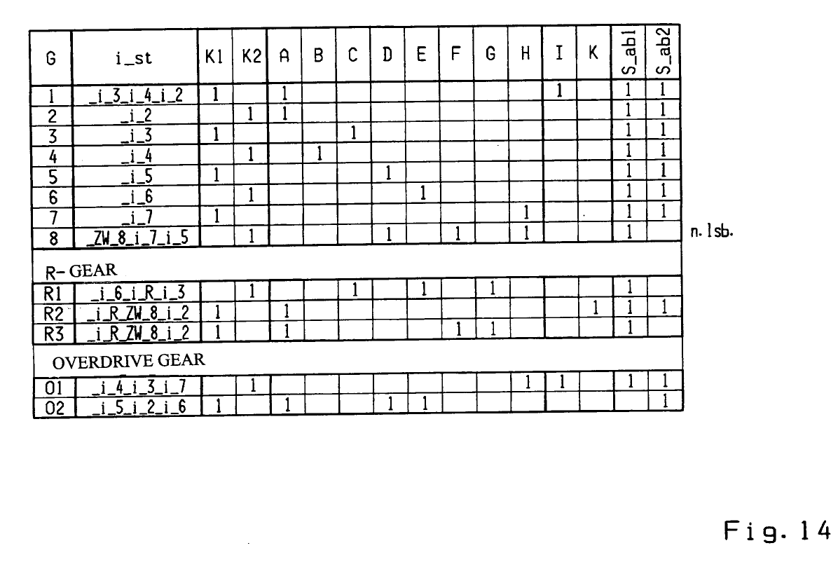

The table depicted in FIG. 14 shows an example of a shift pattern for the 7th variant embodiment of the eight-speed double clutch transmission according to FIG. 13.

It is evident from the shift pattern that the first forward gear G1 is shiftable by means of the first clutch K1 and the activated coupling device A, and also as a winding path gear by means of the activated shift element I, that the second forward gear G2 is shiftable by means of the second clutch K2 and the activated coupling device A, that the third forward gear G3 is shiftable by means of the first clutch K1 and the activated coupling device C, that the fourth forward gear G4 is shiftable by means of the second clutch K2 and the activated coupling device B, that the fifth forward gear G5 is shiftable by means of the first clutch K1 and the activated coupling device D, that the sixth forward gear G6 is shiftable by means of the second clutch K2 and the activated coupling device E, and that the seventh forward gear G7 is shiftable by means of the first clutch K1 and the activated coupling device H. Thus, at least the first seven forward gears can be designed to be power shiftable. Furthermore, the eighth forward gear G8 can be shifted by means of the second clutch K2, the activated coupling device D, the activated coupling device F and the activated coupling device H, and also as a winding path gear when coupling device S_ab2 is disengaged.

In addition, a reverse gear R1 can be shifted by means of the second clutch K2, the activated coupling device C, the activated coupling device E and the activated coupling device G, and also as a winding path gear when coupling device S_ab2 is disengaged, and/or a reverse gear R2 can be shifted by means of the first clutch K1 and the activated coupling device A, and also as a winding path gear by means of the activated shift element K, and/or a reverse gear R3 can be shifted by means of the first clutch K1, the activated coupling device A, the activated coupling device F and the activated coupling device G, and also as a winding path gear when coupling device S_ab2 is disengaged.

Furthermore, in the 7th variant embodiment an overdrive gear O1 can be shifted by means of the second clutch K2 and the activated coupling device H, and also as a winding path gear by means of the activated shift element I, and/or an overdrive gear O2 can be shifted by means of the first clutch K1, the activated coupling device A, the activated coupling device D and the activated coupling device E, and also as a winding path gear when a coupling device S_ab1 is disengaged.

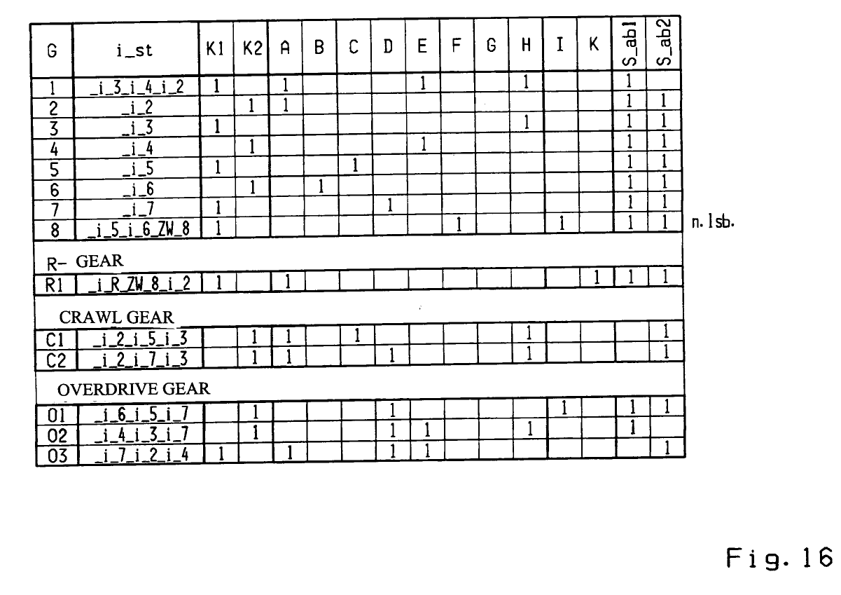

The table depicted in FIG. 16 shows an example of a shift pattern for the 8th variant embodiment of the eight-speed double clutch transmission according to FIG. 15.

It is evident from the shift pattern that the first forward gear G1 is shiftable by means of the first clutch K1, the activated coupling device A, the activated coupling device E and the activated coupling device H, and also as a winding path gear when coupling device S_ab2 is disengaged, that the second forward gear G2 is shiftable by means of the second clutch K2 and the activated coupling device A, that the third forward gear G3 is shiftable by means of the first clutch K1 and the activated coupling device H, that the fourth forward gear G4 is shiftable by means of the second clutch K2 and the activated coupling device E, that the fifth forward gear G5 is shiftable by means of the first clutch K1 and the activated coupling device C, that the sixth forward gear G6 is shiftable by means of the second clutch K2 and the activated coupling device B, and that the seventh forward gear G7 is shiftable by means of the first clutch K1 and the activated coupling device D. Thus, at least the first seven forward gears can be designed to be power shiftable. Furthermore, the eighth forward gear G8 can be shifted by means of the first clutch K1 and the activated coupling device F, and also as a winding path gear by means of the activated shift element I.

In addition, a reverse gear R1 for example can be shifted by means of the first clutch K1 and the activated coupling device A, and also as a winding path gear by means of the activated shift element K.

Moreover, a crawler gear C1 can be shifted by means of the second clutch K2, the activated coupling device A, the activated coupling device C and the activated coupling device H, and also as a winding path gear when a coupling device S_ab1 is disengaged, and/or a crawler gear C2 can be shifted by means of the second clutch K2, the activated coupling device A, the activated coupling device D and the activated coupling device H, and also as a winding path gear when a coupling device S_ab1 is disengaged.

Finally, an overdrive gear O1 can be shifted by means of the second clutch K2 and the activated coupling device D, and also as a winding path gear by means of the activated shift element I, and/or an overdrive gear O2 can be shifted by means of the second clutch K2, the activated coupling device D, the activated coupling device E and the activated coupling device H, and also as a winding path gear when coupling device S_ab2 is disengaged, and/or an overdrive gear O3 can be shifted by means of the first clutch K1, the activated coupling device A, the activated coupling device D and the activated coupling device E, and also as a winding path gear when a coupling device S_ab1 is disengaged.

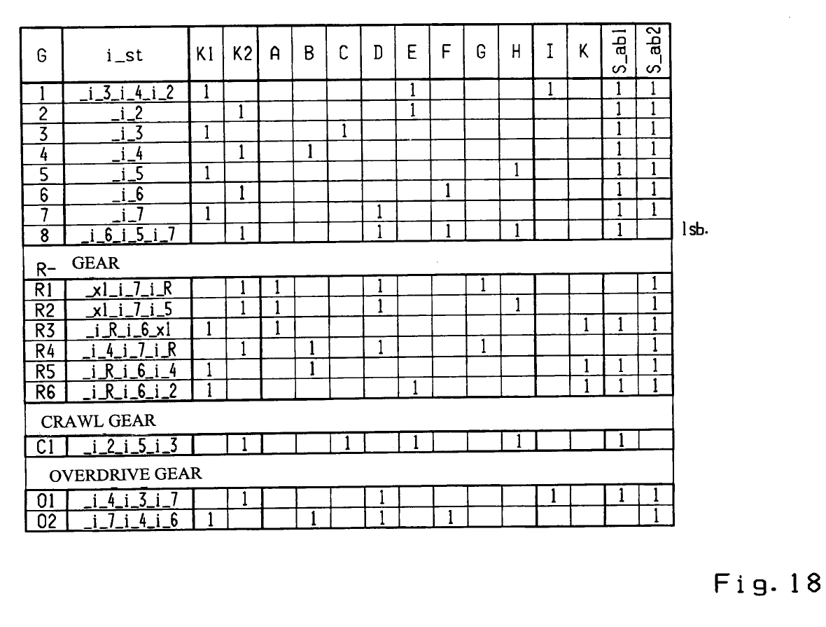

The table depicted in FIG. 18 shows an example of a shift pattern for the 9th variant embodiment of the eight-speed double clutch transmission according to FIG. 17.

It is evident from the shift pattern that the first forward gear G1 is shiftable by means of the first clutch K1 and the activated coupling device E, and also as a winding path gear by means of the activated shift element I, that the second forward gear G2 is shiftable by means of the second clutch K2 and the activated coupling device E, that the third forward gear G3 is shiftable by means of the first clutch K1 and the activated coupling device C, that the fourth forward gear G4 is shiftable by means of the second clutch K2 and the activated coupling device B, that the fifth forward gear G5 is shiftable by means of the first clutch K1 and the activated coupling device H, that the sixth forward gear G6 is shiftable by means of the second clutch K2 and the activated coupling device F, that the seventh forward gear G7 is shiftable by means of the first clutch K1 and the activated coupling device D, and that the eighth forward gear G8 is shiftable by means of the second clutch K2, the activated coupling device D, the activated coupling device F and the activated coupling device H, and also as a winding path gear when coupling device S_ab2 is disengaged. Thus, at least the first eight forward gears can be designed to be power shiftable.

Furthermore, a reverse gear R1 for example is shiftable by means of the second clutch K2, the activated coupling device A, the activated coupling device D and the activated coupling device G, and also as a winding path gear when a coupling device S_ab1 is disengaged, and/or a reverse gear R2 is shiftable by means of the second clutch K2, the activated coupling device A, the activated coupling device D and the activated coupling device H, and also as a winding path gear when a coupling device S_ab1 is disengaged, and/or a reverse gear R3 is shiftable by means of the first clutch K1 and the activated coupling device A, and also as a winding path gear by means of the activated shift element K, and/or a reverse gear R4 is shiftable by means of the second clutch K2, the activated coupling device B, the activated coupling device D and the activated coupling device G, and also as a winding path gear when a coupling device S_ab1 is disengaged, and/or a reverse gear R5 is shiftable by means of the first clutch K1 and the activated coupling device B, and also as a winding path gear by means of the activated shift element K, and/or a reverse gear R6 is shiftable by means of the first clutch K1 and the activated coupling device E, and also as a winding path gear by means of the activated shift element K.

Furthermore, in the 9th variant embodiment a crawler gear C1 can be shifted by means of the second clutch K2, the activated coupling device C, the activated coupling device E and the activated coupling device H, and also as a winding path gear when coupling device S_ab2 is disengaged.

Furthermore, an overdrive gear O1 can be shifted by means of the second clutch K2 and the activated coupling device D, and also as a winding path gear by means of the activated shift element I, and/or an overdrive gear O2 can be shifted by means of the first clutch K1, the activated coupling device B, the activated coupling device D and the activated coupling device F, and also as a winding path gear when a coupling device S_ab1 is disengaged.

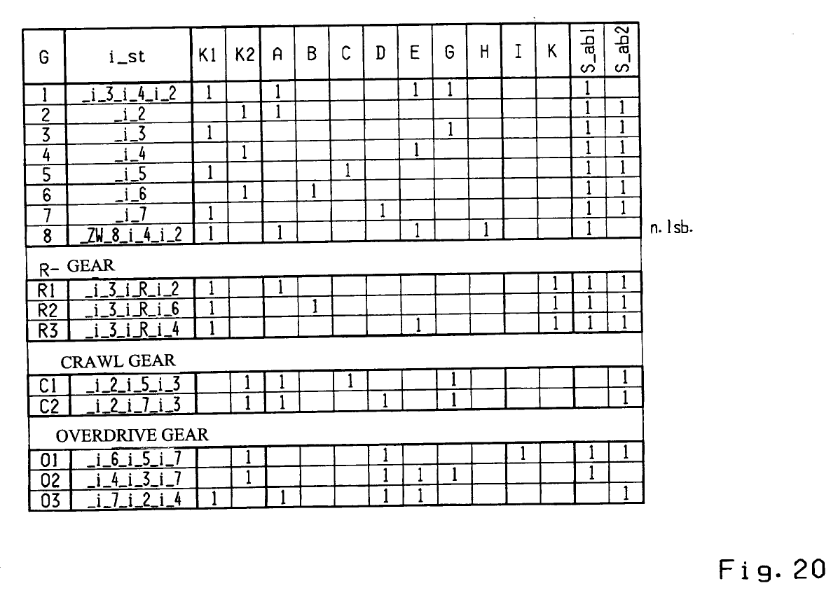

The table depicted in FIG. 20 shows an example of a shift pattern for the 10th variant embodiment of the eight-speed double clutch transmission according to FIG. 19.

It is evident from the shift pattern that the first forward gear G1 is shiftable by means of the first clutch K1, the activated coupling device A, the activated coupling device E and the activated coupling device G, and also as a winding path gear when coupling device S_ab2 is disengaged, that the second forward gear G2 is shiftable by means of the second clutch K2 and the activated coupling device A, that the third forward gear G3 is shiftable by means of the first clutch K1 and the activated coupling device G, that the fourth forward gear G4 is shiftable by means of the second clutch K2 and the activated coupling device E, that the fifth forward gear G5 is shiftable by means of the first clutch K1 and the activated coupling device C, that the sixth forward gear G6 is shiftable by means of the second clutch K2 and the activated coupling device B, and that the seventh forward gear G7 is shiftable by means of the first clutch K1 and the activated coupling device D. Thus, at least the first seven forward gears can be designed to be power shiftable. Furthermore, the eighth forward gear G8 can be shifted by means of the first clutch K1, the activated coupling device A, the activated coupling device E and the activated coupling device H, and also as a winding path gear when coupling device S_ab2 is disengaged.

In addition, in the 10th variant embodiment a reverse gear R1 for example can be shifted by means of the first clutch K1 and the activated coupling device A, and also as a winding path gear by means of the activated shift element K, and/or a reverse gear R2 can be shifted by means of the first clutch K1 and the activated coupling device B, and also as a winding path gear by means of the activated shift element K, and/or a reverse gear R3 can be shifted by means of the first clutch K1 and the activated coupling device E, and also as a winding path gear by means of the activated shift element K.

Moreover, a crawler gear C1 for example can be shifted by means of the second clutch K2, the activated coupling device A, the activated coupling device C and the activated coupling device G, and also as a winding path gear when a coupling device S_ab1 is disengaged, and/or a crawler gear C2 can be shifted by means of the second clutch K2, the activated coupling device A, the activated coupling device D and the activated coupling device G, and also as a winding path gear when a coupling device S_ab1 is disengaged.

Furthermore, an overdrive gear O1 for example can be shifted by means of the second clutch K2 and the activated coupling device D, and also as a winding path gear by means of the activated shift element I, and/or an overdrive gear O2 can be shifted by means of the second clutch K2, the activated coupling device D, the activated coupling device E and the activated coupling device G, and also as a winding path gear when coupling device S_ab2 is disengaged, and/or an overdrive gear O3 can be shifted by means of the first clutch K1, the activated coupling device A, the activated coupling device D and the activated coupling device E, and also as a winding path gear when a coupling device S_ab1 is disengaged.

The shift pattern according to FIG. 2 shows in detail that in the first forward gear G1, starting from the first clutch K1 the gear stages i_3, i_4 and i_2 are used, with the coupling of the two subtransmissions occurring with coupling device S_ab2 disengaged. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. In the eighth forward gear G8, starting from the second clutch K2 the gear stages or gear steps ZW_8, i_3 and i_5 are used, with the two subtransmissions being coupled with coupling device S_ab2 disengaged in the first variant embodiment.

In addition, in reverse gear R1, starting from the second clutch K2, gear stages ZW_8, i_R and i_3 are used, the two subtransmissions being coupled to each other when shift element K is activated. Furthermore, the next reverse gear R2 starting from the second clutch K2 uses the gear stages i_4, i_R and i_5, the coupling device S_ab2 being disengaged to couple the two subtransmissions. The crawler gear C1, starting from the second clutch K2, uses the gear stages i_2, i_5 and i_3, the two subtransmissions being coupled when coupling device S_ab1 is disengaged. The crawler gear C2, starting from the second clutch K2, uses the gear stages i_2, i_7 and i_3, the two subtransmissions being coupled when coupling device S_ab1 is disengaged. The overdrive gear O1, starting from the second clutch K2, uses the gear stages i_6, i_5 and i_7, the two subtransmissions being coupled by means of the activated shift element I. The overdrive gear O2, starting from the second clutch K2, uses the gear stages i_4, i_3 and i_7, the two subtransmissions being coupled when coupling device S_ab2 is disengaged. The overdrive gear O3, starting from the second clutch K2, uses the gear stages i_7, i_2 and i_4, the two subtransmissions being coupled when coupling device S_ab1 is disengaged.

The shift pattern according to FIG. 4 shows in detail that in the first forward gear G1, starting from the first clutch K1 the gear stages i_5, i_6 and i_2 are used, the two subtransmissions being coupled with each other when coupling device S_ab2 is disengaged. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the second clutch K2, uses the gear stages i_6, i_5 and i_7, the coupling device S_ab2 being disengaged to couple the two subtransmissions. In addition, starting from the second clutch K2, the reverse gear R1 uses gear stages_6, i_R and i_7, the shift element K being activated to couple the two subtransmissions. In addition, in the next reverse gear R2, starting from the second clutch K2, gear stages_6, i_R and i_3 are used, the two subtransmissions being coupled to each other when shift element K is activated. In reverse gear R3, starting from the second clutch K2, gear stages x_6, i_R and i_5 are used, the two subtransmissions being coupled when shift element K is activated. The reverse gear R4, starting from the second clutch K2, uses the gear stages i_6, i_R and i_3, the two subtransmissions being coupled when coupling device S_ab2 is disengaged. The reverse gear R5, starting from the second clutch K2, uses the gear stages_6, i_R and i_7, the two subtransmissions being coupled when coupling device S_ab2 is disengaged. The reverse gear R6, starting from the second clutch K2, uses the gear stages_6, i_R and i_3, the two subtransmissions being coupled when coupling device S_ab2 is disengaged.

The crawler gear C1, starting from the second clutch K2, uses the gear stages i_2, i_7 and i_4, the two subtransmissions being coupled by means of the activated shift element I. The crawler gear C2, starting from the second clutch K2, uses the gear stages i_2, i_7 and i_5, shift element I being activated to couple the two subtransmissions. The overdrive gear O1, starting from the first clutch K1, uses the gear stages i_7, i_2 and i_4, the two subtransmissions being coupled by means of the activated shift element I. The overdrive gear O2, starting from the first clutch K1, uses the gear stages i_7, i_2 and i_6, shift element I being activated to couple the two subtransmissions. The overdrive gear O3, starting from the first clutch K1, uses the gear stages i_7, i_4 and i_6, coupling device S_ab1 being disengaged to couple the two subtransmissions.

The shift pattern according to FIG. 6 shows in detail that in the first forward gear G1, starting from the first clutch K1 the gear stages i_3, i_4 and i_2 are used, the two subtransmissions being coupled with each other by means of the activated shift element I. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the second clutch K2, uses the gear stages i_6, i_5 and i_7, the coupling device S_ab2 being disengaged to couple the two subtransmissions. In addition, the reverse gear R1, starting from the second clutch K2, uses the gear stage i_R. The reverse gear R2, starting from the second clutch K2, uses the gear stages i_R, i_5 and i_3, the two subtransmissions being coupled to each other in reverse gear R2 when coupling device S_ab2 is disengaged. The reverse gear R3, starting from the first clutch K1, uses gear stages i_3, i_4 and i_R, the two subtransmissions being coupled to each other when shift element I is activated. The reverse gear R4, starting from the first clutch K1, uses gear stages _x7, i_6 and i_R, the two subtransmissions being coupled to each other when shift element K is activated. The reverse gear R5, starting from the second clutch K2, uses the gear stages i_2, i_3 and _x7, the two subtransmissions being coupled to each other in reverse gear R5 when coupling device S_ab1 is disengaged. The reverse gear R6, starting from the second clutch K2, uses the gear stages i_2, i_7 and _x7, the two subtransmissions being coupled to each other in reverse gear R6 when coupling device S_ab1 is disengaged. The reverse gear R7, starting from the second clutch K2, uses the gear stages i_4, i_7 and _x7, the two subtransmissions being coupled to each other when coupling device S_ab1 is disengaged. The reverse gear R8, starting from the first clutch K1, uses gear stages _x7, i_6 and i_2, the two subtransmissions being coupled to each other when shift element K is activated. The reverse gear R9, starting from the first clutch K1, uses gear stages _x7, i_6 and i_4, the two subtransmissions being coupled to each other when shift element K is activated. The reverse gear R10, starting from the first clutch K1, uses gear stages _x7, i_6 and i_2, the two subtransmissions being coupled to each other when coupling device S_ab2 is disengaged. The reverse gear R11, starting from the first clutch K1, uses gear stages _x7, i_6 and i_4, the two subtransmissions being coupled to each other when coupling device S_ab2 is disengaged.

Furthermore, the crawler gear C1, starting from the second clutch K2, uses the gear stages i_2, i_7 and i_5, the subtransmissions being coupled when coupling device S_ab1 is disengaged. The overdrive gear O1, starting from the second clutch K2, uses the gear stages i_4, i_3 and i_7, the two subtransmissions being coupled with each other by means of the activated shift element I. The overdrive gear O2, starting from the first clutch K1, uses the gear stages i_7, i_2 and i_6, the two subtransmissions being coupled when coupling device S_ab1 is disengaged. The overdrive gear O3, starting from the first clutch K1, uses the gear stages i_7, i_4 and i_6, the two subtransmissions being coupled when coupling device S_ab1 is disengaged.

The shift pattern according to FIG. 8 shows in detail that in the first forward gear G1, starting from the first clutch K1, the gear stages i_3, i_4 and i_2 are used, the two subtransmissions being coupled when coupling device S_ab2 is disengaged. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the first clutch K1, uses the gear stages i_7, ZW_8 and i_4, the two subtransmissions being coupled by means of the activated shift element I. In addition, the reverse gear R1, starting from the second clutch K2, uses the gear stages i_4, i_R and i_5, the two subtransmissions being coupled when coupling device S_ab2 is disengaged.

The crawler gear C1, starting from the second clutch K2, uses the gear stages i_2, i_7 and i_3, the two subtransmissions being coupled when a coupling device S_ab1 is disengaged. The crawler gear C2, starting from the second clutch K2, uses the gear stages i_2, i_5 and i_3, the two subtransmissions being coupled when a coupling device S_ab1 is disengaged. In addition, the crawler gear C3, starting from the first clutch K1, uses gear stages i_3, i_6 and i_2, the two subtransmissions being coupled to each other by means of the activated shift element K. The crawler gear C4, starting from the first clutch K1, uses gear stages i_3, i_6 and i_2, the two subtransmissions being coupled to each other when coupling device S_ab2 is disengaged. In addition, the overdrive gear O1, starting from the second clutch K2, uses the gear stages i_6, i_3 and i_7, the two subtransmissions being coupled with each other by means of the shift element K. The overdrive gear O2, starting from the second clutch K2, uses the gear stages i_6, i_3 and i_5, the two subtransmissions being coupled with each other by means of the shift element K. The overdrive gear O3, starting from the second clutch K2, uses the gear stages i_4, i_3 and i_7, the two subtransmissions being coupled when coupling device S_ab2 is disengaged. The overdrive gear O4, starting from the first clutch K1, uses the gear stages i_7, i_2 and i_4, the two subtransmissions being coupled when a coupling device S_ab1 is disengaged. The overdrive gear O5, starting from the first clutch K1, uses the gear stages i_7, i_2 and i_6, the two subtransmissions being coupled when a coupling device S_ab1 is disengaged. The overdrive gear O6, starting from the first clutch K1, uses the gear stages i_5, i_2 and i_6, the two subtransmissions being coupled when a coupling device S_ab1 is disengaged. The overdrive gear O7, starting from the second clutch K2, uses the gear stages i_6, i_3 and i_7, the two subtransmissions being coupled when coupling device S_ab2 is disengaged. The overdrive gear O8, starting from the second clutch K2, uses the gear stages i_6, i_3 and i_5, the two subtransmissions being coupled when coupling device S_ab2 is disengaged.

The shift pattern according to FIG. 10 shows in detail that in the first forward gear G1, starting from the first clutch K1 the gear stages i_3, i_4 and i_2 are used, the two subtransmissions being coupled by means of the activated shift element I. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the second clutch K2, uses the gear stages i_4, i_3 and ZW_8, the subtransmissions being coupled by means of the activated shift element I. In addition, the reverse gear R1, starting from the second clutch K2, uses the gear stages i_R, i_7 and i_3, the two subtransmissions being coupled when coupling device S_ab2 is disengaged.

The overdrive gear O1, starting from the second clutch K2, uses the gear stages i_4, i_3 and i_7, the two subtransmissions being coupled with each other by means of a shift element I. In addition, the overdrive gear O2, starting from the second clutch K2, uses the gear stages i_6, i_5 and i_7, the two subtransmissions being coupled with each other by means of the activated shift element K.

The shift pattern according to FIG. 12 shows in detail that in the first forward gear G1, starting from the first clutch K1 the gear stages i_3, i_4 and i_2 are used, the two subtransmissions being coupled with each other by means of the activated shift element I. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the first clutch K1, uses the gear stages ZW_8, i_6 and i_4, the two subtransmissions being coupled when coupling device S_ab2 is disengaged. In addition, the reverse gear R1, starting from the second clutch K2, uses the gear stages i_R, ZW_8 and i_3, the two subtransmissions being coupled when coupling device S_ab2 is disengaged. The next reverse gear R2, starting from the second clutch K2, uses the gear stages i_R, ZW_8 and i_7, the two subtransmissions being coupled when coupling device S_ab2 is disengaged.

The crawler gear C1, starting from the second clutch K2, uses the gear stages i_2, i_7 and i_5, the two subtransmissions being coupled with each other when a coupling device S_ab1 is disengaged. The overdrive gear O1, starting from the second clutch K2, uses the gear stages i_4, i_3 and i_7, the two subtransmissions being coupled with each other when shift element I is activated. In addition, the overdrive gear O2, starting from the second clutch K2, uses the gear stages i_6, i_5 and i_7, the two subtransmissions being coupled with each other when shift element K is activated. In addition, the overdrive gear O3, starting from the first clutch K1, uses the gear stages i_7, i_2 and i_6, the subtransmissions being coupled with each other when a coupling device S_ab1 is disengaged. The overdrive gear O4, starting from the first clutch K1, uses the gear stages i_7, i_4 and i_6, the two subtransmissions being coupled with each other when a coupling device S_ab1 is disengaged. In addition, the overdrive gear O5, starting from the second clutch K2, uses the gear stages i_6, i_5 and i_7, the two subtransmissions being coupled with each other when coupling device S_ab2 is disengaged.

The shift pattern according to FIG. 14 shows in detail that in the first forward gear G1, starting from the first clutch K1 the gear stages i_3, i_4 and i_2 are used, the two subtransmissions being coupled with each other by means of the activated shift element I. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the second clutch K2, uses the gear stages ZW_8, i_7 and i_5, the two subtransmissions being coupled with each other when coupling device S_ab2 is disengaged. In addition, the reverse gear R1, starting from the second clutch K2, uses the gear stages i_6, i_R and i_3, the subtransmissions being coupled when coupling device S_ab2 is disengaged. The next reverse gear R2, starting from the first clutch K1, uses the gear stages i_R, ZW_8 and i_2, the subtransmissions being coupled by means of the activated shift element K. The reverse gear R3, starting from the first clutch K1, uses the gear stages i_R, ZW_8 and i_2, the two subtransmissions being coupled when coupling device S_ab2 is disengaged.

The overdrive gear O1, starting from the second clutch K2, uses the gear stages i_4, i_3 and i_7, the two subtransmissions being coupled with each other when shift element I is activated. In addition, the overdrive gear O2, starting from the first clutch K1, uses the gear stages i_5, i_2 and i_6, the two subtransmissions being coupled with each other when a coupling device S_ab1 is disengaged.

The shift pattern according to FIG. 16 shows in detail that in the first forward gear G1, starting from the first clutch K1 the gear stages i_3, i_4 and i_2 are used, the two subtransmissions being coupled with each other when coupling device S_ab2 is disengaged. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the first clutch K1, uses the gear stages i_5, i_6 and ZW_8, the two subtransmissions being coupled with each other when the shift element I is activated. In addition, the reverse gear R1, starting from the first clutch K1, uses the gear stages i_R, ZW_8 and i_2, the subtransmissions being coupled when shift element K is activated.

The crawler gear C1, starting from the second clutch K2, uses the gear stages i_2, i_5 and i_3, the two subtransmissions being coupled with each other when a coupling device S_ab1 is disengaged. The crawler gear C2, starting from the second clutch K2, uses the gear stages i_2, i_7 and i_3, the two subtransmissions being coupled with each other when a coupling device S_ab1 is disengaged. The overdrive gear O1, starting from the second clutch K2, uses the gear stages i_6, i_5 and i_7, the two subtransmissions being coupled with each other when shift element I is activated. The overdrive gear O2, starting from the second clutch K2, uses the gear stages i_4, i_3 and i_7, the two subtransmissions being coupled with each other when coupling device S_ab2 is disengaged. In addition, the overdrive gear O3, starting from the first clutch K1, uses the gear stages i_7, i_2 and i_4, the two subtransmissions being coupled with each other when a coupling device S_ab1 is disengaged.

The shift pattern according to FIG. 18 shows in detail that in the first forward gear G1, starting from the first clutch K1 the gear stages i_3, i_4 and i_2 are used, the two subtransmissions being coupled with each other by means of the activated shift element I. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the second clutch K2, uses the gear stages i_6, i_5 and i_7, the two subtransmissions being coupled with each other when coupling device S_ab2 is disengaged. In addition, the reverse gear R1, starting from the second clutch K2, uses the gear stages _x1, i_7 and i_R, the subtransmissions being coupled when coupling device S_ab1 is disengaged. The reverse gear R2, starting from the second clutch K2, uses the gear stages _x1, i_7 and i_5, the subtransmissions being coupled when coupling device S_ab1 is disengaged. The next reverse gear R3, starting from the first clutch K1, uses the gear stages i_R, i_6 and _x1, the subtransmissions being coupled when shift element K is activated. The reverse gear R4, starting from the second clutch K2, uses the gear stages i_4, i_7 and i_R, the subtransmissions being coupled when coupling device S_ab1 is disengaged. The next reverse gear R5, starting from the first clutch K1, uses the gear stages i_R, i_6 and i_4, the subtransmissions being coupled when shift element K is activated. The next reverse gear R6, starting from the first clutch K1, uses the gear stages i_R, i_6 and i_2, the subtransmissions being coupled when shift element K is activated.

The crawler gear C1, starting from the second clutch K2, uses the gear stages i_2, i_5 and i_3, the two subtransmissions being coupled with each other when coupling device S_ab2 is disengaged. The overdrive gear O1, starting from the second clutch K2, uses the gear stages i_4, i_3 and i_7, the two subtransmissions being coupled with each other when shift element I is activated. In addition, the overdrive gear O2, starting from the first clutch K1, uses the gear stages i_7, i_4 and i_6, the two subtransmissions being coupled with each other when a coupling device S_ab1 is disengaged.

The shift pattern according to FIG. 20 shows in detail that in the first forward gear G1, starting from the first clutch K1 the gear stages i_3, i_4 and i_2 are used, the two subtransmissions being coupled with each other when coupling device S_ab2 is disengaged. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the first clutch K1, uses the gear stages ZW_8, i_4 and i_2, the two subtransmissions being coupled when coupling device S_ab2 is disengaged. In addition, the reverse gear R1, starting from the first clutch K1, uses the gear stages i_3, i_R and i_2, the subtransmissions being coupled when shift element K is activated. The next reverse gear R2, starting from the first clutch K1, uses the gear stages i_3, i_R and i_6, the subtransmissions being coupled when shift element K is activated. The reverse gear R3, starting from the first clutch K1, uses gear stages i_3, i_R and i_4, the two subtransmissions being coupled with each other when shift element K is activated.

The crawler gear C1, starting from the second clutch K2, uses the gear stages i_2, i_5 and i_3, the two subtransmissions being coupled with each other when coupling device S_ab1 is disengaged. The crawler gear C2, starting from the second clutch K2, uses the gear stages i_2, i_7 and i_3, the two subtransmissions being coupled with each other when a coupling device S_ab1 is disengaged. The overdrive gear O1, starting from the second clutch K2, uses the gear stages i_6, i_5 and i_7, the two subtransmissions being coupled with each other when shift element I is activated. In addition, the overdrive gear O2, starting from the second clutch K2, uses the gear stages i_4, i_3 and i_7, the two subtransmissions being coupled with each other when coupling device S_ab2 is disengaged. The overdrive gear O3, starting from the second clutch K2, uses the gear stages i_7, i_2 and i_4, the two subtransmissions being coupled with each other when coupling device S_ab1 is disengaged.

In summary, the result for the 1st and 2nd variant embodiments according to FIGS. 1 through 4 is that a winding path gear coupling device S_ab2 assigned to output gear 18 is provided, without an additional shift element.

In the first variant embodiment, two dual gear planes and four single gear planes are provided. In addition, a non-power-shiftable winding path gear is provided as an eighth forward gear. Furthermore, an additional overdrive gear O2 that is power-shiftable to the seventh forward gear is realized as an alternative power-shiftable eighth forward gear, to save fuel.

In detailed terms, the result for the 1st variant embodiment is that in the first gear plane 8-12, as a dual gear plane, idler gear 8 is used for five forward gears, G1, G2, C1, C2, O3 and idler gear 12 for four forward gears G1, G4, O2, O3 and for one reverse gear R2. In the second gear plane 9-2, as a single gear plane, idler gear 9 is used for two forward gears G6, O1. In the third gear plane 3-13, as a single gear plane, idler gear 13 is used for one forward gear G8 and for one reverse gear R1. In the fourth gear plane 10-14, as a dual gear plane, idler gear 10 is used for four forward gears G5, G8, C1, O1 and for one reverse gear R2, and idler gear 14 for two reverse gears R1, R2. In the fifth gear plane 11-5, as a single gear plane, idler gear 11 is used for five forward gears G7, C2, O1, O2, O3. In the sixth gear plane 6-15, as a single gear plane, idler gear 15 is used for six forward gears G1, G3, G8, C1, C2, O2 and for one reverse gear R1.

In summary, the result for the 2nd variant embodiment according to FIGS. 3 and 4, with three dual gear planes and one single gear plane, is a power-shiftable eighth forward gear as a winding path gear.

In detailed terms, the result for the 2nd variant embodiment is that in the first gear plane 8-12, as a dual gear plane, idler gear 8 is used for four forward gears G4, C1, O1, O3 and idler gear 12 for five forward gears G1, G6, G8, O2, O3 and for one reverse gear R4. In the second gear plane 9-2, as a single gear plane, idler gear 9 is used for six forward gears G1, G2, C1, C2, O1, O2. In the third gear plane 10-14, as a dual gear plane, idler gear 10 is used for seven forward gears G7, G8, C1, C2, O1, O2, O3 and for two reverse gears R1, R5, and idler gear 14 for six reverse gears R1 through R6. In the fourth gear plane 11-15, as a dual gear plane, idler gear 11 is used for one forward gear G3 and for three reverse gears R2, R4, R6, and idler gear 15 for four forward gears G1, G5, G8, C2 and for one reverse gear R3.

In summary, the result for the 3rd through 7th variant embodiments according to FIGS. 5-14 is that a winding path gear coupling device S_ab2 assigned to output gear 18 and a winding path gear shift element I assigned to first countershaft w_v1 are used.

In the 3rd variant embodiment, two dual gear planes and three single gear planes, as well as one power-shiftable eighth forward gear, are provided. A further result is that an additional overdrive gear O1 that is power-shiftable to the seventh forward gear is realized as an alternative power-shiftable eighth forward gear, to save fuel.

In detailed terms, the result for the 3rd variant embodiment is that in the first gear plane 8-12, as a dual gear plane, idler gear 8 is used for four forward gears, G1, G2, C1, O2 and for four reverse gears R5, R6, R8, R10, and idler gear 12 for four reverse gears R1 through R4. In the second gear plane 9-2, as a single gear plane, idler gear 9 is used for four forward gears G1, G4, O1, O3 and for four reverse gears R3, R7, R9, R11. In the third gear plane 3-13, as a single gear plane, idler gear 13 is used for four forward gears G6, G8, O2, O3 and for five reverse gears R4, R8, R9, R10, R11. In the fourth gear plane 10-4, as a single gear plane, idler gear 10 is used for three forward gears G1, G3, O1 and for three reverse gears R2, R3, R5. In the fifth gear plane 11-15, as a dual gear plane, idler gear 11 is used for six forward gears G7, G8, C1, O1, O2, O3 and for two reverse gears R6, R7, and idler gear 15 for three forward gears R5, R8, C1 and for one reverse gear R2.

In summary, the result for the 4th variant embodiment according to FIGS. 7 and 8, with two dual gear planes and four single gear planes, is an eighth non-power-shiftable forward gear. In addition, a crawler gear C4 that is power shiftable to the second gear is realized as an alternative first forward gear for better off-road driving properties. Another result is two additional overdrive gears O7, O3 that are power shiftable to the seventh forward gear, as alternative power-shiftable eighth forward gears to save fuel.

In detailed terms, the result for the 4th variant embodiment is that in the first gear plane 8-12, as a dual gear plane, idler gear 8 is used for nine forward gears, G1, G2, C1, C2, C3, C4, O4, O5, O6 and idler gear 12 for five forward gears G1, G4, G8, O3, O4 and for one reverse gear R1. In the second gear plane 9-2, as a single gear plane, idler gear 9 is used for one forward gear G8. In the third gear plane 3-13, as a single gear plane, idler gear 13 is used for nine forward gears G6, C3, C4, O1, O2, O5, O6, O7, O8. In the fourth gear plane 10-4, as a single gear plane, idler gear 10 is used for eight forward gears G7, G8, C1, O1, O3, O4, O5, O7. In the fifth gear plane 5-14, as a single gear plane, idler gear 14 is used for eleven forward gears G1, G3, C1, C2, C3, C4, O1, O2, O3, O7, O8. In the sixth gear plane 11-15, as a dual gear plane, idler gear 11 is used for five forward gears G5, C2, O2, O6, O8 and for one reverse gear R1, and idler gear 15 for one reverse gear R1.

In summary, the result for the 5th variant embodiment according to FIGS. 9 and 10, with three dual gear planes and two single gear planes, is a non-power-shiftable eighth forward gear. Furthermore, an additional overdrive gear O1 that is power shiftable to the seventh forward gear can be realized as an alternative power-shiftable eighth forward gear, to save fuel.

In detailed terms, the result for the 5th variant embodiment is that in the first gear plane 8-12, as a dual gear plane, idler gear 8 is used for two forward gears G1, G2 and idler gear 12 for one reverse gear R1. In the second gear plane 9-13, as a dual gear plane, idler gear 9 is used for four forward gears G1, G4, G8, O1 and idler gear 13 for two forward gears G6, O2. In the third gear plane 10-14, as a dual gear plane, idler gear 10 is used for four forward gears G1, G3, G8, O1 and for one reverse gear R1, and idler gear 14 for two forward gears G5, O2. In the fourth gear plane 11-4, as a single gear plane, idler gear 11 is used for one forward gear G8. In the fifth gear plane 5-15, as a single gear plane, idler gear 15 is used for three forward gears G7, O1, O2 and for one reverse gear R1.

In summary, the result for the 6th variant embodiment, with three dual gear planes and two single gear planes, is a non-power-shiftable eighth forward gear. Furthermore, two additional overdrive gears O1, O5 that are power shiftable to the seventh forward gear can be realized as alternative power-shiftable eighth forward gears, to save fuel.

In detailed terms, the result for the 6th variant embodiment is that in the first gear plane 8-12, as a dual gear plane, idler gear 8 is used for four forward gears G1, G2, C1, O3 and idler gear 12 for two reverse gears R1, R2. In the second gear plane 9-2, as a single gear plane, idler gear 9 is used for five forward gears G1, G4, G8, O1, O4. In the third gear plane 3-13, as a single gear plane, idler gear 13 is used for six forward gears G6, G8, O2, O3, O4, O5. In the third gear plane 10-14, as a dual gear plane, idler gear 10 is used for three forward gears G1, G3, O1 and for one reverse gear R1, and idler gear 14 for four forward gears G5, C1, O2, O5. In the fifth gear plane 11-15, as a dual gear plane, idler gear 11 is used for seven forward gears G7, C1, O1 through O5 and for one reverse gear R2, and idler gear 15 for one forward gear G8 and for two reverse gears R1, R2.

For the 7th variant embodiment, the result with three dual gear planes and two single gear planes is a non-power-shiftable eighth forward gear. In addition, a reverse gear R3 that is power shiftable to the second forward gear can be realized, thereby enabling rocking free when stuck. Furthermore, an additional overdrive gear O1 that is power shiftable to the seventh forward gear can be realized as an alternative power-shiftable eighth forward gear, to save fuel.

In detailed terms, the result for the 7th variant embodiment is that in the first gear plane 8-12, as a dual gear plane, idler gear 8 is used for three forward gears G1, G2, O2 and for two reverse gears R2, R3, and idler gear 12 for two forward gears G6, O2 and for one reverse gear R1. In the second gear plane 9-13, as a dual gear plane, idler gear 9 is used for three forward gears C1, G4, O1, and idler gear 13 for one forward gear G8 and two reverse gears R2, R3. In the third gear plane 10-14, as a dual gear plane, idler gear 10 is used for three forward gears G1, G3, O1 and for one reverse gear R1, and idler gear 14 for three reverse gears R1 through R3. In the fourth gear plane 11-4, as a single gear plane, idler gear 11 is used for three forward gears G5, G8, O2. In the fifth gear plane 5-15, as a single gear plane, idler gear 15 is used for two forward gears G7, O1.

In the 8th and 9th variant embodiments according to FIGS. 15-18, a winding path gear coupling device S_ab2 and a winding path gear shift element I assigned to first countershaft w_v1, as well as a winding path gear shift element K assigned to the second countershaft, are provided.

In the 8th variant embodiment according to FIG. 15, three dual gear planes and two single gear planes are provided. In addition, a reverse gear R1 that is power shiftable to the second forward gear can be realized, thereby enabling rocking free when stuck. Furthermore, two additional overdrive gears O1, O2 that are power shiftable to the seventh forward gear can be realized as alternative power-shiftable eighth forward gears, to enable fuel savings.

In detailed terms, the result for the 8th variant embodiment is that in the first gear plane 8-12, as a dual gear plane, idler gear 8 is used for five forward gears, G1, G2, C1, C2, O3, and idler gear 12 for four forward gears G1, G4, O2, O3. In the second gear plane 9-13, as a dual gear plane, idler gear 9 is used for three forward gears G6, G8, O1, and idler gear 13 for one forward gear G8 and one reverse gear R1. In the third gear plane 10-14, as a dual gear plane, idler gear 10 is used for four forward gears G5, G8, C1, O1 and idler gear 14 for one reverse gear R1. In the fourth gear plane 11-4, as a single gear plane, idler gear 11 is used for five forward gears G7, C2, O1, O2, O3. In the fifth gear plane 5-15, as a single gear plane, idler gear 15 is used for five forward gears G1, G3, C1, C2, O2.

In the 9th variant embodiment, two dual gear planes and three single gear planes, as well as one power-shiftable eight forward gear in the form of a winding path gear, are provided. Another result is a reverse gear R6 that is power shiftable to the second forward gear, thereby enabling rocking free when stuck. Furthermore, an additional overdrive gear O1 that is power shiftable to the seventh forward gear is realized as an alternative power-shiftable eighth forward gear, to save fuel.

In detailed terms, the result for the 9th variant embodiment is that in the first gear plane 1-12, as a single gear plane, idler gear 12 is used for three forward gears G1, G2, C1 and for one reverse gear R6. In the second gear plane 9-2, as a single gear plane, idler gear 9 is used for four forward gears G1, G4, O1, O2 and for two reverse gears R4, R5. In the third gear plane 3-13, as a single gear plane, idler gear 13 is used for three forward gears G6, G8, O2 and for three reverse gears R3, R5, R6. In the fourth gear plane 10-14, as a dual gear plane, idler gear 10 is used for four forward gears G1, G3, C1, O1 and idler gear 14 for five reverse gears R1, R3, R4, R5, R6. In the fifth gear plane 11-15, as a dual gear plane, idler gear 11 is used for four forward gears G7, G8, O1, O2 and for three reverse gears R1, R2, R4, and idler gear 15 for three forward gears G5, G8, C1 and for one reverse gear R2.

In summary, the result for the 10th variant embodiment according to FIG. 19, with a winding path gear coupling device S_ab2 assigned to output gear 18 and a winding path gear shift element K assigned to the second countershaft w_v2, is an arrangement with three dual gear planes and two single gear planes. In addition, a reverse gear R1 that is power shiftable to the second forward gear is realized, thereby enabling rocking free when stuck. A further result is that an additional overdrive gear O2 that is power-shiftable to the seventh forward gear is realized as an alternative power-shiftable eighth forward gear, to save fuel.

In detailed terms, the result for the 10th variant embodiment is that in the first gear plane 8-12, as a dual gear plane, idler gear 8 is used for six forward gears G1, G2, G8, C1, C2, O3 and for one reverse gear R1, and idler gear 12 for five forward gears G1, G4, G8, O2, O3 and for one reverse gear R3. In the second gear plane 9-13, as a dual gear plane, idler gear 9 is used for two forward gears G6, O1 and for one reverse gear R2, and idler gear 13 for three reverse gears R1 through R3. In the third gear plane 10-3, as a single gear plane, idler gear 10 is used for three forward gears G5, C1, O1. In the fourth gear plane 4-14, as a single gear plane, idler gear 14 is used for five forward gears G1, G3, C1, C2, O2 and for three reverse gears R1 through R3. In the fifth gear plane 11-15, as a dual gear plane, idler gear 11 is used for five forward gears G7, C2, O1, O2, O3 and idler gear 15 for one forward gear G8.

It is possible that in one or more variant embodiments at least one additional gear stage ZW_x (e.g., ZW_8) may be utilized for winding path gears, that are not used in a direct forward gear. The utilization of an additional gear stage is evident from the figures for the respective variant embodiments.

It is also possible to use gear wheels x1, x2, . . . x7, x8 for additional winding path gears, which may be added to supplement a single gear plane, the gear wheels x1, x2, . . . x7, x8 being numbered as follows. The numbering begins with the first gear wheel x1 of the first countershaft w_v1, starting from the assigned output stage i_ab_1 and continuing sequentially until the fourth gear wheel x4, the first gear wheel on the second countershaft w_v2 starting from the assigned output stage i_ab_2 being designated as x5 and the additional gear wheels being designated continuously up to x8. If the additional gear wheel x1, x2, . . . x7, x8 is used in a reverse gear transmission, a rotation reversal will take place, as for example through the use of an intermediate gear on an intermediate shaft w_zw or the like.

In all variant embodiments of the double clutch transmission, because of these provisions for multiple use of individual idler gears, fewer gear planes are necessary, and thus fewer parts while the number of gears remains the same, so that an advantageous saving of construction space and cost is achieved.

Independent of the particular variant embodiment, the number “1” in a field of the particular table of the shift patterns according to FIGS. 2, 4, 6, 8, 10, 12, 14, 16, 18 and 20 means that the assigned clutch K1, K2 or the assigned coupling device A, B, C, D, E, F, G, H or the assigned shift element I, K is engaged or activated. On the other hand, a blank field in the particular table of the shift patterns according to FIGS. 2, 4, 6, 8, 10, 12, 14, 16, 18 and 20 means that the assigned clutch K1, K2 or the assigned coupling device A, B, C, D, E, F, G, H or the assigned shift element I, K is disengaged.

For the coupling device S_ab1 or S_ab2 assigned to an output gear 17 or 18, deviating from the previously stated rules, when there is a blank field in the respective table of the shift patterns according to FIGS. 2, 4, 6, 8, 10, 12, 14, 16, 18 and 20 coupling device S_ab1 or S_ab2 must be disengaged, and when there is a field with the number “1” in the respective table of the shift patterns according to FIGS. 2, 4, 6, 8, 10, 12, 14, 16, 18 and 20 the coupling device S_ab1 or S_ab2 should be engaged. Depending on the gear, the coupling element S_ab1 or S_ab2 must be engaged even in the case of a group of gears where there is a field with the number “1,” whereas in contrast, for a different group of gears where there is a field with the number “1,” the coupling element S_ab1 or S_ab2 may be either disengaged or engaged.

Furthermore, in many cases the possibility exists of inserting additional coupling or shift elements without influencing the flow of force. This can enable gear preselection.

### REFERENCE SYMBOLS

1 fixed gear of the second transmission input shaft
2 fixed gear of the second transmission input shaft
3 fixed gear of the first or second transmission input shaft
4 fixed gear of the first transmission input shaft
5 fixed gear of the first transmission input shaft
6 fixed gear of the first transmission input shaft
8 idler gear of the first countershaft
9 idler gear of the first countershaft
10 idler gear of the first countershaft
11 idler gear of the first countershaft
12 idler gear of the first countershaft
13 idler gear of the second countershaft
14 idler gear of the second countershaft
15 idler gear of the second countershaft
16 fixed gear of the output shaft
17 output gear of the first countershaft
18 output gear of the first countershaft
19 torsion vibration damper
K1 first clutch
K2 second clutch
w_an drive shaft
w_ab output shaft
w_v1 first countershaft
w_v2 second countershaft
w_k1 first transmission input shaft
w_k2 second transmission input shaft
A coupling device
B coupling device
C coupling device
D coupling device
E coupling device
F coupling device
G coupling device
H coupling device
i_2 gear stage of second forward gear
i_3 gear stage of third forward gear
i_4 gear stage of fourth forward gear
i_5 gear stage of fifth forward gear
i_6 gear stage of sixth forward gear
i_7 gear stage of seventh forward gear
ZW_8 additional gear stage for winding path gears
_x1 gear wheel for additional winding path gears
_x6 gear wheel for additional winding path gears
_x7 gear wheel for additional winding path gears
i_ab_1 output stage on the first countershaft
i_ab_2 output stage on the second countershaft
G1 first forward gear
G2 second forward gear
G3 third forward gear
G4 fourth forward gear
G5 fifth forward gear
G6 sixth forward gear
G7 seventh forward gear
G8 eighth forward gear
C1 crawler gear
C2 crawler gear
C3 crawler gear
C4 crawler gear
O1 overdrive gear
O2 overdrive gear
O3 overdrive gear
O4 overdrive gear
O5 overdrive gear
O6 overdrive gear
O7 overdrive gear
O8 overdrive gear
R1 reverse gear
R2 reverse gear
R3 reverse gear
R4 reverse gear
R5 reverse gear
R6 reverse gear
R7 reverse gear
R8 reverse gear
R9 reverse gear
R10 reverse gear
R11 reverse gear
w_zw intermediate shaft
ZR intermediate gear for rotation reversal
ZS utilized gear stage
I shift element
K shift element
S_ab1 coupling device on the output shaft, optional
S_ab2 coupling device on the output shaft
n. lsb. non-power-shiftable
lsb. power-shiftable

1-24. (canceled)

25. A double clutch transmission comprising
first and second clutches (K1, K2) each comprising an input side connected to a drive shaft (w_an) and an output side respectively connected to one of first and second transmission input shafts (w_k1, w_k2) arranged coaxially with respect to each other;
at least first and second countershafts (w_v1, w_v2) each supporting toothed idler gearwheels (8, 9, 10, 11, 12, 13, 14, 15);
toothed fixed gears (1, 2, 3, 4, 5, 6) being supported on the first and the second transmission input shafts (w_k1, w_k2) in a rotationally fixed manner and meshing with at least one of the idler gearwheels (8, 9, 10, 11, 12, 13, 14, 15);
a plurality of coupling devices (A, B, C, D, E, F, G, H) for coupling an idler gearwheel (8, 9, 10, 11, 12, 13, 14, 15) to one of the first and the second countershafts (w_v1, w_v2) in a rotationally fixed manner;
an output gear (17, 18) being supported on each of the first and the second countershafts, and each output gear (17, 18) engaging gearing of an output shaft (w_ab) such that at least several power-shiftable gears (1, 2, 3, 4, 5, 6, 7) and at least one reverse gear (R1, R2, R3, R4, R5, R6, R7, R8, R9, R10, R11) being shiftable;
a maximum of six gear planes (1-12, 8-12, 9-2, 9-13, 3-13, 10-3, 10-4, 10-14, 4-14, 11-4, 5-14, 11-5, 11-15, 5-15, 6-15) being provided and comprising at least two dual gear planes (8-12, 9-13, 10-14, 11-15), each of the dual gear planes (8-12, 9-13, 10-14, 11-15) comprising one idler gearwheel (8, 9, 10, 11, 12, 13, 14, 15) of each of the first and the second countershafts (w_v1, w_v2) and a fixed gearwheel (1, 2, 3, 4, 5, 6) of one of the first and the second transmission input shafts (w_k1, w_k2), at least one idler gearwheel (8, 9, 10, 11, 12, 13, 14, 15) in each of the dual gear planes (8-12, 9-13, 10-14, 11-15) being utilized for at least two gears such that at least one winding path gear being shiftable by disengagement of a coupling device (S_ab2) supported on the second countershaft (w_v2).

26. The double clutch transmission according to claim 25, wherein at least one of a first forward gear (G1), an eighth forward gear (G8), at least one reverse gear (R1, R2, R3, R4, R5, R6, R10, R11), a crawler gear (C1, C4) and at least one overdrive gear (O2, O3, O5, O7, O8) is shiftable as a winding path gear disengagement of the coupling device (S_ab2) on the second countershaft (w_v2).

27. The double clutch transmission according to claim 25, wherein at least one shift element (I) is supported on the first countershaft (w_v1), an idler gearwheel (9) of a second sub-transmission is connectable to an idler gearwheel (10) of a first sub-transmission by activation of the at least one shift element (I) such that at least one of a first forward gear (G1) and an eighth forward gear (G8) or at least one reverse gear (R3) and at least one overdrive gear (O1, O2) is shiftable as a winding path gear.

28. The double clutch transmission according to claim 25, wherein at least another shift element (K) is supported on the second countershaft (w_v2), an idler gearwheel (13) of a second sub-transmission is connectable with an idler gearwheel (14) of a first sub-transmission by activation of at least another shift element (K), such that at least one of a reverse gear (R1, R2, R3, R4, R5, R6, R8, R9), one crawler gear (C3), and at least one overdrive gear (O1, O2) is shiftable as a winding path gear by activation of at least another shift element (K).

29. The double clutch transmission according to claim 25, wherein the coupling device (S_ab2) assigned to the output gear (18) and at least another shift element (K) are supported on the second countershaft (w_v2), and that the at least one shift element (I) is supported on the first countershaft (w_v1).

30. The double clutch transmission according to claim 25, wherein the double clutch transmission comprises four gear planes (8-12, 9-2, 10-4, 11-5) of which a first gear plane (8-12) is a dual gear plane, and a second gear plane (9-2) is a single gear plane, and the first and the second gear planes are assigned to the fixed gearwheels (1, 2) of the second transmission input shaft (w_k2) of a second sub-transmission, and
a third gear plane (10-14) and a fourth gear plane (11-15) are each a dual gear plane, and the third and the fourth gear planes are assigned to the fixed gearwheels (4, 5) of the first transmission input shaft (w_k1) of a first sub-transmission.

31. The double clutch transmission according to claim 25, wherein the double clutch transmission comprises first, second, third, fourth and fifth gear planes (1-12, 8-12, 9-2, 9-13, 3-13, 10-3, 10-4, 10-14, 11-4, 4-14, 11-15, 5-15).

32. The double clutch transmission according to claim 31, wherein the first gear plane (8-12) and the second gear plane (9-13) are each a dual gear plane, and the first and the second gear planes are assigned to the fixed gearwheels (1, 2) of the second transmission input shaft (w_k2) of a second sub-transmission, and the third gear plane (10-3, 10-14) is one of a single gear plane and a dual gear plane, the fourth gear plane (4-14; 11-4) is a single gear plane, and the fifth gear plane (11-15, 5-15) is one of a dual gear plane and a single gear plane, and the third, the fourth and the fifth gear planes are assigned to the fixed gearwheels (3, 4, 5) of the first transmission input shaft (w_k1) of a first sub-transmission.

33. The double clutch transmission according to claim 31, wherein the first gear plane (8-12, 1-12) is one of a dual gear plane and a single gear plane, the second gear plane (9-2) is a single gear plane, and the third gear plane (3-13) is a single gear plane, and the first, the second and the third gear planes are assigned to the fixed gearwheels (1, 2, 3) of the second transmission input shaft (w_k2) of a second sub-transmission, and the fourth gear plane (10-14) is one of a dual gear plane and a single gear plane and a fifth gear plane (11-15) is a dual gear plane, and the fourth and the fifth gear planes are assigned to the fixed gearwheels (4, 5) of the first transmission input shaft (w_k1) of the first sub-transmission.

34. The double clutch transmission according to claim 25, wherein six gear planes (8-12, 9-2, 3-13, 10-4, 5-14, 10-14, 11-5, 6-15, 11-15) are provided, where a first gear plane (8-12) is a dual gear plane, a second gear plane (9-2) is a single gear plane and a third gear plane (3-13) is a single gear plane, and the first, the second and the third gear planes are assigned to the fixed gearwheels (1, 2, 3) of the second transmission input shaft (w_k2) of the second sub-transmission, and
a fourth gear plane (10-14, 10-4) is one of a dual gear plane and a single gear plane, a fifth gear plane (5-14, 11-5) is a single gear plane, and a sixth gear plane (11-15, 6-15) is one of a dual gear plane and a single gear plane, and the fourth, the fifth and the six gear planes are assigned to the fixed gearwheels (4, 5, 6) of the first transmission input shaft (w_k1) of a first sub-transmission.

35. The double clutch transmission according to claim 25, wherein
a first forward gear (G1) is shiftable as a winding path gear via activation of the first clutch (K1), a first coupling device (A), a fifth coupling device (E) and an eighth coupling device (H) and disengagement of the coupling device (S_ab2) of the second countershaft (w_v2);
a second forward gear (G2) is shiftable via activation of the second clutch (K2) and a first coupling device (A);
a third forward gear (G3) is shiftable via activation of the first clutch (K1) and an eighth coupling device (H);
a fourth forward gear (G4) is shiftable via activation of the second clutch (K2) and the fifth coupling device (E);
a fifth forward gear (G5) is shiftable via activation of the first clutch (K1) and a third coupling device (C);
a sixth forward gear (G6) is shiftable via activation of the second clutch (K2) and a second coupling device (B);
a seventh forward gear (G7) is shiftable via activation of the first clutch (K1) and a fourth coupling device (D);
an eighth forward gear (G8) is shiftable as a winding path gear via activation of the second clutch (K2), the third coupling device (C), a sixth coupling device (F), the eighth coupling device (H) and disengagement of the coupling device (S_ab2) of the second countershaft (w_v2);
a first reverse gear (R1) is shiftable as a winding path gear via activation of the second clutch (K2), the eighth coupling device (H) and at least another shift element (K);
a second reverse gear (R2) is shiftable as a winding path gear via activation of the second clutch (K2), the third coupling device (C), the fifth coupling device (E), the seventh coupling device (G) and disengagement of the coupling device (S_ab2) of the second countershaft (w_v2);
a first crawler gear (C1) is shiftable as a winding path gear via activation of the second clutch (K2), the first coupling device (A), the third coupling device (C), the eighth coupling device (H) and disengagement of the coupling device (S_ab1) of the first countershaft (w_v1);
a second crawler gear (C2) is shiftable as a winding path gear via activation of the second clutch (K2), the first coupling device (A), the fourth coupling device (D), the eighth coupling device (H) and disengagement of the coupling device (S_ab1) of the first countershaft (w_v1);
a first overdrive gear (O1) is shiftable as a winding path gear via activation of the second clutch (K2), the fourth coupling device (D) and the at least one shift element (I);
a second overdrive gear (O2) is shiftable as a winding path gear via activation of the second clutch (K2), the fourth coupling device (D), the fifth coupling device (E) and the eighth coupling device (H) and disengagement of the coupling device (S_ab2) of the second countershaft (w_v2); and
a third overdrive gear (O3) is shiftable as a winding path gear via activation of the first clutch (K1), the first coupling device (A), the fourth coupling device (D) and the fifth coupling device (E) and disengagement of the coupling device (S_ab1) of the first countershaft (w_v1).

36. The double clutch transmission according to claim 25, wherein
a first forward gear (G1) is shiftable a winding path gear via activation of the first clutch (K1), a second coupling device (B), a fifth coupling device (E) and an eighth coupling device (H) and disengagement of the coupling device (S_ab2) of the second countershaft (w_v2);
a second forward gear (G2) is shiftable via activation of the second clutch (K2) and the second coupling device (B);
a third forward gear (G3) is shiftable via activation of the first clutch (K1) and a fourth coupling device (D);
a fourth forward gear (G4) is shiftable via activation of the second clutch (K2) and a first coupling device (A);
a fifth forward gear (G5) is shiftable via activation of the first clutch (K1) and an eighth coupling device (H);
a sixth forward gear (G6) is shiftable via activation of the second clutch (K2) and the fifth coupling device (E);
a seventh forward gear (G7) is shiftable via activation of the first clutch (K1) and a third coupling device (C);
an eighth forward gear (G8) is shiftable as a winding path gear via activation of the second clutch (K2), the third coupling device (C), the fifth coupling device (E) and the eighth coupling device (H) and disengagement of the coupling device (S_ab2) of the second countershaft (w_v2);
a first reverse gear (R1) is shiftable as a winding path gear via activation of the second clutch (K2), third coupling device (C) and a second shift element (K);
a second reverse gear (R2) is shiftable as a winding path gear via activation of the second clutch (K2), the fourth coupling device (D) and the second shift element (K);
a third reverse gear (R3) is shiftable as a winding path gear via activation of the second clutch (K2), the eighth coupling device (H) and the second shift element (K);
a fourth reverse gear (R3) is shiftable as a winding path gear via activation of the second clutch (K2), the fourth coupling device (D), the fifth coupling device (E) and the seventh coupling device (G) and disengagement of the coupling device (S_ab2) of the second countershaft (w_v2);
a fifth reverse gear (R5) is shiftable as a winding path gear via activation of the second clutch (K2), the third coupling device (C), the sixth coupling device (F), and the seventh coupling device (G) and disengagement of the coupling device (S_ab2) of the second countershaft (w_v2); and
a sixth reverse gear (R6) is shiftable as a winding path gear via activation of the second clutch (K2), the fourth coupling device (D), the sixth coupling device (F) and the seventh coupling device (G) and disengagement of the coupling device (S_ab2) of the second countershaft (w_v2).

37. The double clutch transmission according to claim 36, wherein
a first crawler gear (C1) is shiftable as a winding path gear via activation of the second clutch (K2), the fourth coupling device (D) and the at least one shift element (I);
a second crawler gear (C2) is shiftable as a winding path gear via activation of the second clutch (K2), the eighth coupling device (H) and the at least one shift element (I);
a first overdrive gear (O1) is shiftable as a winding path gear via activation of the first clutch (K1), the first coupling device (A) and the at least one shift element (I);
a second overdrive gear (O2) is shiftable as a winding path gear via activation of the first clutch (K1), the fifth coupling device (E) and the at least one shift element (I); and
a third overdrive gear (O3) is shiftable as a winding path gear via activation of the first clutch (K1), the first coupling device (A), the third coupling device (C) and the fifth coupling device (E) and disengagement of the coupling device (S_ab1) of the first countershaft (w_v1).

38. The double clutch transmission according to claim 25, wherein
a first forward gear (G1) is shiftable as a winding path gear via activation of the first clutch (K1), a first coupling device (A) and a first shift element (I);
a second forward gear (G2) is shiftable via activation of the second clutch (K2) and the first coupling device (A);
a third forward gear (G3) is shiftable via activation of the first clutch (K1) and a third coupling device (C);
a fourth forward gear (G4) is shiftable via activation of the second clutch (K2) and a second coupling device (B);
a fifth forward gear (G5) is shiftable via activation of the first clutch (K1) and an eighth coupling device (H);
a sixth forward gear (G6) is shiftable via activation of the second clutch (K2) and a sixth coupling device (F);
a seventh forward gear (G7) is shiftable via activation of the first clutch (K1) and a fourth coupling device (D);
an eighth forward gear (G8) is shiftable as a winding path gear via activation of the second clutch (K2), the fourth coupling device (D), the sixth coupling device (F) and the eighth coupling device (H) and disengagement of the coupling device (S_ab2) of the second countershaft (w_v2);
a first reverse gear (R1) is shiftable via activation of the second clutch (K2) and a fifth coupling device (E);
a second reverse gear (R2) is shiftable as a winding path gear via activation of the second clutch (K2), the third coupling device (C), the fifth coupling device (E) and the eighth coupling device (H) and disengagement of the coupling device (S_ab2) of the second countershaft (w_v2);
a third reverse gear (R3) is shiftable as a winding path gear via activation of the first clutch (K1), the fifth coupling device (E) and the first shift element (I);
a fourth reverse gear (R3) is shiftable as a winding path gear via activation of the first clutch (K1), the fifth coupling device (E) and a second shift element (K);
a fifth reverse gear (R5) is shiftable as a winding path gear via activation of the second clutch (K2), the first coupling device (A), the third coupling device (C) and the seventh coupling device (G) and disengagement of the coupling device (S_ab1) of the first countershaft (w_v1);
a sixth reverse gear (R6) is shiftable as a winding path gear via activation of the second clutch (K2), the first coupling device (A), the fourth coupling device (D) and the seventh coupling device (G) and disengagement of the coupling device (S_ab1) of the first countershaft (w_v1);
a seventh reverse gear (R7) is shiftable as a winding path gear via activation of the second clutch (K2), the second coupling device (B), the fourth coupling device (D) and the seventh coupling device (G) and disengagement of the coupling device (S_ab1) of the first countershaft (w_v1);
an eighth reverse gear (R8) is shiftable as a winding path gear via activation of the first clutch (K1), the first coupling device (A) and the second shift element (K);
a ninth reverse gear (R9) is shiftable as a winding path gear via activation of the first clutch (K1), the second coupling device (B) and the second shift element (K);
a tenth reverse gear (R10) is shiftable as a winding path gear via activation of the first clutch (K1), the first coupling device (A), the sixth coupling device (F) and the seventh coupling device (G) and disengagement of the coupling device (S_ab2) of the second countershaft (w_v2); and
an eleventh reverse gear (R11) is shiftable as a winding path gear via activation of the first clutch (K1), the second coupling device (B), the sixth coupling device (F) and the seventh coupling device (G) and disengagement of the coupling device (S_ab2) of the second countershaft (w_v2).

39. The double clutch transmission according to claim 38, wherein
a crawler gear (C1) is shiftable as a winding path gear via activation of the second clutch (K2), the first coupling device (A), the fourth coupling device (D) and the eighth coupling device (H) and disengagement of the coupling device (S_ab1) of the first countershaft (w_v1);
a first overdrive gear (O1) is shiftable as a winding path gear via activation of the second clutch (K2), the fourth coupling device (D) and the at least one shift element (I);
a second overdrive gear (O2) is shiftable as a winding path gear via activation of the first clutch (K1), the first coupling device (A), the fourth coupling device (D) and the sixth coupling device (F) and disengagement of the coupling device (S_ab1) of the first countershaft (w_v1); and
a third overdrive gear (O3) is shiftable as a winding path gear via activation of the first clutch (K1), the second coupling device (B), the fourth coupling device (D) and the sixth coupling device (F) and disengagement of the coupling device (S_ab1) of the first countershaft (w_v1).

40. The double clutch transmission according to claim 25, wherein
a first forward gear (G1) is shiftable as a winding path gear via activation of the first clutch (K1), a first coupling device (A), a fifth coupling device (E) and a seventh coupling device (G) and disengagement of the coupling device (S_ab2) of the second countershaft (w_v2);
a second forward gear (G2) is shiftable via activation of the second clutch (K2) and the first coupling (A);
a third forward gear (G3) is shiftable via activation of the first clutch (K1) and the seventh coupling device (G);
a fourth forward gear (G4) is shiftable via activation of the second clutch (K2) and the fifth coupling device (E);
a fifth forward gear (G5) is shiftable via activation of the first clutch (K1) and a fourth coupling device (D);
a sixth forward gear (G6) is shiftable via activation of the second clutch (K2) and a sixth coupling device (F);
a seventh forward gear (G7) is shiftable via activation of the first clutch (K1) and a third coupling device (C);
an eighth forward gear (G8) is shiftable as a winding path gear via activation of the first clutch (K1), the fifth coupling device (E) and the at least one shift element (I); and
a first reverse gear (R1) is shiftable as a winding path gear via activation of the second clutch (K2), the fourth coupling device (D), the fifth coupling device (E) and an eighth coupling device (H) and disengagement of the coupling device (S_ab2) of the second countershaft (w_v2).

41. The double clutch transmission according to claim 40, wherein a first crawler gear (C1) is shiftable as a winding path gear via activation of the second clutch (K2), first coupling device (A), the third coupling device (C) and the seventh coupling device (G) and disengagement of the coupling device (S_ab1) of the first countershaft (w_v1);
a second crawler gear (C2) is shiftable as a winding path gear via activation of the second clutch (K2), the first coupling device (A), the fourth coupling device (D) and the seventh coupling device (G) and disengagement of the coupling device (S_ab1) of the first countershaft (w_v1);
a third crawler gear (C3) is shiftable as a winding path gear via activation of the first clutch (K1), the first coupling device (A) and a second shift element (K);
a fourth crawler gear (C4) is shiftable as a winding path gear via activation of the first clutch (K1), the first coupling device (A), the sixth coupling device (F) and the seventh coupling device (G) and disengagement of the coupling device (S_ab2) of the second countershaft (w_v2);
a first overdrive gear (O1) is shiftable as a winding path gear via activation of the second clutch (K2), the third coupling device (C) and the second shift element (K);
a second overdrive gear (O2) is shiftable as a winding path gear via activation of the second clutch (K2), the fourth coupling device (D) and the second shift element (K);
a third overdrive gear (O3) is shiftable as a winding path gear via activation of the second clutch (K2), the third coupling device (C), the fifth coupling device (E) and the seventh coupling device (G) and disengagement of the coupling device (S_ab2) of the second countershaft (w_v2);
a fourth overdrive gear (O4) is shiftable as a winding path gear via activation of the first clutch (K1), the first coupling device (A), the third coupling device (C) and the fifth coupling device (E) and disengagement of the coupling device (S_ab1) of the first countershaft (w_v1);
a fifth overdrive gear (O5) is shiftable as a winding path gear via activation of the first clutch (K1), the first coupling device (A), the third coupling device (C) and the sixth coupling device (F) and disengagement of the coupling device (S_ab1) of the first countershaft (w_v1);
a sixth overdrive gear (O6) is shiftable as a winding path gear via activation of the first clutch (K1), the first coupling device (A), the fourth coupling device (D) and the sixth coupling device (F) and disengagement of the coupling device (S_ab1) of the first countershaft (w_v1);
a seventh overdrive gear (O7) is shiftable as a winding path gear via activation of the second clutch (K2), the third coupling device (C), the sixth coupling device (F) and the seventh coupling device (G) and disengagement of the coupling device (S_ab2) of the second countershaft (w_v2); and
an eighth overdrive gear (O8) is shiftable as a winding path gear via activation of the second clutch (K2), the fourth coupling device (D), the sixth coupling device (F) and the seventh coupling device (G) and disengagement of the coupling device (S_ab2) of the second countershaft (w_v2).

42. The double clutch transmission according to claim 25, wherein
a first forward gear (G1) is shiftable as a winding path gear via activation of the first clutch (K1), a first coupling device (A) and a first shift element (I);
a second forward gear (G2) is shiftable via activation of the second clutch (K2) and the first coupling device (A);
a third forward gear (G3) is shiftable via activation of the first clutch (K1) and a third coupling device (C);
a fourth forward gear (G4) is shiftable via activation of the second clutch (K2) and a second coupling device (B);
a fifth forward gear (G5) is shiftable via activation of the first clutch (K1) and a seventh coupling device (G);
a sixth forward gear (G6) is shiftable via activation of the second clutch (K2) and sixth coupling device (F);
a seventh forward gear (G7) is shiftable via activation of the first clutch (K1) and an eighth coupling device (H);
an eighth forward gear (G8) is shiftable as a winding path gear via activation of the second clutch (K2), a fourth coupling device (D) and the at least one shift element (I);
a reverse gear (R1) is shiftable as a winding path gear via activation of the second clutch (K2), the third coupling device (C), a fifth coupling device (E) and an eighth coupling device (H) and disengagement of the coupling device (S_ab2) of the second countershaft (w_v2);
a first overdrive gear (O1) is shiftable as a winding path gear via activation of the second clutch (K2), the eighth coupling device (H) and the at least one shift element (I); and
a second overdrive gear (O2) is shiftable as a winding path gear via activation of the second clutch (K2), the eighth coupling device (H) and a second shift element (K).

43. The double clutch transmission according to claim 25, wherein
a first forward gear (G1) is shiftable as a winding path gear via activation of the first clutch (K1), a first coupling device (A) and the at least one shift element (I);
a second forward gear (G2) is shiftable via activation of the second clutch (K2) and the first coupling device (A);
a third forward gear (G3) is shiftable via activation of the first clutch (K1) and a third coupling device (C);
a fourth forward gear (G4) is shiftable via activation of the second clutch (K2) and a second coupling device (B);
a fifth forward gear (G5) is shiftable via activation of the first clutch (K1) and a seventh coupling device (G);
a sixth forward gear (G6) is shiftable via activation of the second clutch (K2) and a sixth coupling device (F);
a seventh forward gear (G7) is shiftable via activation of the first clutch (K1) and a fourth coupling device (D);
an eighth forward gear (G8) is shiftable as a winding path gear via activation of the first clutch (K1), the second coupling device (B), the sixth coupling device (F) and an eighth coupling device (H) and disengagement of the coupling device (S_ab2) of the second countershaft (w_v2);
a first reverse gear (R1) is shiftable as a winding path gear via activation of the second clutch (K2), the third coupling device (C), a fifth coupling device (E) and the eighth coupling device (H) and disengagement of the coupling device (S_ab2) of the second countershaft (w_v2); and
a second reverse gear (R2) is shiftable as a winding path gear via activation of the second clutch (K2), the fourth coupling device (D), the fifth coupling device (E) and the eighth coupling device (H) and disengagement of the coupling device (S_ab2) of the second countershaft (w_v2).

44. The double clutch transmission according to claim 43, wherein a crawler gear (C1) is shiftable as a winding path gear via activation of the second clutch (K2), the first coupling device (A), the fourth coupling device (D) and the seventh coupling device (G) and disengagement of the coupling device (S_ab1) of the first countershaft (w_v1);
a first overdrive gear (O1) is shiftable as a winding path gear via activation of the second clutch (K2), the fourth coupling device (D) and the at least one shift element (I);
a second overdrive gear (O2) is shiftable as a winding path gear via activation of the second clutch (K2), the fourth coupling device (D) and a second shift element (K);
a third overdrive gear (O3) is shiftable as a winding path gear via activation of the first clutch (K1), the first coupling device (A), the fourth coupling device (D) and the sixth coupling device (F) and disengagement of the coupling device (S_ab1) of the first countershaft (w_v1);
a fourth overdrive gear (O4) is shiftable as a winding path gear via activation of the first clutch (K1), the second coupling device (B), the fourth coupling device (D) and the sixth coupling device (F) and disengagement of the coupling device (S_ab1) of the first countershaft (w_v1); and
a fifth overdrive gear (O5) is shiftable as a winding path gear via activation of the second clutch (K2), fourth coupling device (D), the sixth coupling device (F) and the seventh coupling device (G) and disengagement of the coupling device (S_ab2) of the second countershaft (w_v2).

45. The double clutch transmission according to claim 25, wherein
a first forward gear (G1) is shiftable as a winding path gear via activation of the first clutch (K1), a first coupling device (A) and the at least one shift element (I);
a second forward gear (G2) is shiftable via activation of the second clutch (K2) and the first coupling device (A);
a third forward gear (G3) is shiftable via activation of the first clutch (K1) and a third coupling device (C);
a fourth forward gear (G4) is shiftable via activation of the second clutch (K2) and a second coupling device (B);
a fifth forward gear (G5) is shiftable via activation of the first clutch (K1) and a fourth coupling device (D);
a sixth forward gear (G6) is shiftable via activation of the second clutch (K2) and a fifth coupling device (E);
a seventh forward gear (G7) is shiftable via activation of the first clutch (K1) and an eighth coupling device (H);
a eighth forward gear (G8) is shiftable as a winding path gear via activation of the second clutch (K2), the fourth coupling device (D), a sixth coupling device (F) and the eighth coupling device (H) and disengagement of the coupling device (S_ab2) of the second countershaft (w_v2);
a first reverse gear (R1) is shiftable as a winding path gear via activation of the second clutch (K2), third coupling device (C), the fifth coupling device (E) and a seventh coupling device (G) and disengagement of the coupling device (S_ab2) of the second countershaft (w_v2);
a second reverse gear (R2) is shiftable as a winding path gear via activation of the first clutch (K1), the first coupling device (A) and a second shift element (K);
a third reverse gear (R3) is shiftable as a winding path gear via activation of the first clutch (K1), the first coupling device (A), the sixth coupling device (F) and the seventh coupling device (G) and disengagement of the coupling device (S_ab2) of the second countershaft (w_v2);
a first overdrive gear (O1) is shiftable as a winding path gear via activation of the second clutch (K2), the eighth coupling device (H) and the at least one shift element (I); and
a second overdrive gear (O2) is shiftable as a winding path gear via activation of the first clutch (K1), the first coupling device (A), the fourth coupling device (D) and the fifth coupling device (E) and disengagement of the coupling device (S_ab1) of the first countershaft (w_v1).

46. The double clutch transmission according to claim 25, wherein
a first forward gear (G1) is shiftable as a winding path gear via activation of the first clutch (K1), a first coupling device (A), a fifth coupling device (E) and an eighth coupling device (H) and disengagement of the coupling device (S_ab2) of the second countershaft (w_v2);
a second forward gear (G2) is shiftable via activation of the second clutch (K2) and a first coupling device (A);
a third forward gear (G3) is shiftable via activation of the first clutch (K1) and an eighth coupling device (H);
a fourth forward gear (G4) is shiftable via activation of the second clutch (K2) and the fifth coupling device (E);
a fifth forward gear (G5) is shiftable via activation of the first clutch (K1) and a third coupling device (C);
a sixth forward gear (G6) is shiftable via activation of the second clutch (K2) and a second coupling device (B);
a seventh forward gear (G7) is shiftable via activation of the first clutch (K1) and a fourth coupling device (D);
an eighth forward gear (G8) is shiftable as a winding path gear via activation of the first clutch (K1), a sixth coupling device (F) and the at least one shift element (I);
a first reverse gear (R1) is shiftable as a winding path gear via activation of the first clutch (K1), the first coupling device (A) and a second shift element (K);
a first crawler gear (C1) is shiftable as a winding path gear via activation of the second clutch (K2), the first coupling device (A), the third coupling device (C) and the eighth coupling device (H) and disengagement of the coupling device (S_ab1) of the first countershaft (w_v1);
a second crawler gear (C2) is shiftable as a winding path gear via activation of the second clutch (K2), the first coupling device (A), the fourth coupling device (D) and the eighth coupling device (H) and disengagement of the coupling device (S_ab1) of the first countershaft (w_v1);
a first overdrive gear (O1) is shiftable as a winding path gear via activation of the second clutch (K2), the fourth coupling device (D) and the at least one shift element (I);
a second overdrive gear (O2) is shiftable as a winding path gear via activation of the second clutch (K2), the fourth coupling device (D), the fifth coupling device (E) and the eighth coupling device (H) and disengagement of the coupling device (S_ab2) of the second countershaft (w_v2); and
a third overdrive gear (O3) is shiftable as a winding path gear via activation of the first clutch (K1), the first coupling device (A), the fourth coupling device (D) and the fifth coupling device (E) and disengagement of the coupling device (S_ab1) of the first countershaft (w_v1).

47. The double clutch transmission according to claim 25, wherein
a first forward gear (G1) is shiftable as a winding path gear via activation of the first clutch (K1), a fifth coupling device (E) and the at least one shift element (I);
a second forward gear (G2) is shiftable via activation of the second clutch (K2) and the fifth coupling device (E);
a third forward gear (G3) is shiftable via activation of the first clutch (K1) and a third coupling device (C);
a fourth forward gear (G4) is shiftable via activation of the second clutch (K2) and a second coupling device (B);
a fifth forward gear (G5) is shiftable via activation of the first clutch (K1) and an eighth coupling device (H);
a sixth forward gear (G6) is shiftable via activation of the second clutch (K2) and a sixth coupling device (F);
a seventh forward gear (G7) is shiftable via activation of the first clutch (K1) and a fourth coupling device (D);
an eighth forward gear (G8) is shiftable as a winding path gear via activation of the second clutch (K2), the fourth coupling device (D), the sixth coupling device (F) and the eighth coupling device (H) and disengagement of the coupling device (S_ab2) of the second countershaft (w_v2);
a first reverse gear (R1) is shiftable as a winding path gear via activation of the second clutch (K2), a first coupling device (A), the fourth coupling device (D) and a seventh coupling device (G) and disengagement of the coupling device (S_ab1) of the first countershaft (w_v1);
a second reverse gear (R2) is shiftable as a winding path gear via activation of the second clutch (K2), the first coupling device (A), the fourth coupling device (D) and the eighth coupling device (H) and disengagement of the coupling device (S_ab1) of the first countershaft (w_v1);
a third reverse gear (R3) is shiftable as a winding path gear via activation of the first clutch (K1), the first coupling device (A) and the second shift element (K);
a fourth reverse gear (R3) is shiftable as a winding path gear via activation of the second clutch (K2), the second coupling device (B), the fourth coupling device (D) and the seventh coupling device (G) and disengagement of the coupling device (S_ab1) of the first countershaft (w_v1);
a fifth reverse gear (R5) is shiftable as a winding path gear via activation of the first clutch (K1), the second coupling device (B) and a second shift element (K);
a sixth reverse gear (R6) is shiftable as a winding path gear via activation of the first clutch (K1), the fifth coupling device (E) and the second shift element (K);
a crawler gear (C1) is shiftable as a winding path gear via activation of the second clutch (K2), the third coupling device (C), the fifth coupling device (E) and the eighth coupling device (H) and disengagement of the coupling device (S_ab2) of the second countershaft (w_v2);
a first overdrive gear (O1) is shiftable as a winding path gear via activation of the second clutch (K2), the fourth coupling device (D) and the at least one shift element (I); and
a second overdrive gear (O2) is shiftable as a winding path gear via activation of the first clutch (K1), the second coupling device (B), the fourth coupling device (D) and the sixth coupling device (F) and disengagement of the coupling device (S_ab1) of the first countershaft (w_v1).

48. The double clutch transmission according to claim 25, wherein
a first forward gear (G1) is shiftable as a winding path gear via activation of the first clutch (K1), a first coupling device (A), a fifth coupling device (E) and a seventh coupling device (G) and disengagement of the coupling device (S_ab2) of the second countershaft (w_v2);
a second forward gear (G2) is shiftable via activation of the second clutch (K2) and the first coupling device (A);
a third forward gear (G3) is shiftable via activation of the first clutch (K1) and a seventh coupling device (G);
a fourth forward gear (G4) is shiftable via activation of the second clutch (K2) and the fifth coupling device (E);
a fifth forward gear (G5) is shiftable via activation of the first clutch (K1) and a third coupling device (C);
a sixth forward gear (G6) is shiftable via activation of the second clutch (K2) and a second coupling device (B);
a seventh forward gear (G7) is shiftable via activation of the first clutch (K1) and a fourth coupling device (D);
a eighth forward gear (G8) is shiftable as a winding path gear via activation of the first clutch (K1), the first coupling device (A), the fifth coupling device (E) and an eighth coupling device (H) and disengagement of the coupling device (S_ab2) of the second countershaft (w_v2);
a first reverse gear (R1) is shiftable as a winding path gear via activation of the first clutch (K1), the first coupling device (A) and a second shift element (K);
a second reverse gear (R2) is shiftable as a winding path gear via activation of the first clutch (K1), the second coupling device (B) and the second shift element (K);
a third reverse gear (R3) is shiftable as a winding path gear via activation of the first clutch (K1), the fifth coupling device (E) and the second shift element (K);
a first crawler gear (C1) is shiftable as a winding path gear via activation of the second clutch (K2), the first coupling device (A), the third coupling device (C) and the seventh coupling device (G) and disengagement of a coupling device (S_ab1) of the first countershaft (w_v1);
a second crawler gear (C2) is shiftable as a winding path gear via activation of the second clutch (K2), the first coupling device (A), the fourth coupling device (D) and the seventh coupling device (G) and disengagement of the coupling device (S_ab1) of the first countershaft (w_v1);
a first overdrive gear (O1) is shiftable as a winding path gear via activation of the second clutch (K2), the fourth coupling device (D) and the at least one shift element (I);
a second overdrive gear (O2) is shiftable as a winding path gear via activation of the second clutch (K2), the fourth coupling device (D), the fifth coupling device (E) and the seventh coupling device (G) and disengagement of the coupling device (S_ab2) of the second countershaft (w_v2);
a third overdrive gear (O3) is shiftable as a winding path gear via activation of the first clutch (K1), the first coupling device (A), the fourth coupling device (D) and the fifth coupling device (E) and disengagement of the coupling device (S_ab1) of the first countershaft (w_v1).
